(19) United States
(12) Patent Application Publication
(10) Pub. No.: US 2024/0285466 A1
(43) Pub. Date: Aug. 29, 2024

(54) MASSAGE DEVICE CAPABLE OF FORWARD AND BACKWARD TILTING

(71) Applicant: BODYFRIEND CO., LTD., Seoul (KR)

(72) Inventors: Sung Gu LIM, Seoul (KR); Deok Hyun KONG, Seoul (KR); Myeong Jin YOU, Seoul (KR)

(21) Appl. No.: 18/572,071

(22) PCT Filed: Jul. 26, 2022
(86) PCT No.: PCT/KR2022/010943

§ 371 Date: Dec. 19, 2023

(30) Foreign Application Priority Data
Jul. 27, 2021 (KR) 10-2021-0098666
Oct. 8, 2021 (KR) 10-2021-0134282
Dec. 29, 2021 (KR) 10-2021-0191821
Jan. 18, 2022 (KR) 10-2022-0007160
Jan. 18, 2022 (KR) 10-2022-0007161
Jul. 15, 2022 (KR) 10-2022-0087265
Jul. 25, 2022 (KR) 10-2022-0091999

(51) Int. Cl. A61H 15/00; A47C 1/028; A47C 1/032

(52) U.S. Cl. CPC A61H 15/0078; A47C 1/028; A47C 1/032; A61H 2201/0149

(57) ABSTRACT

Provided is a massage device capable of forward and backward tilting, and the massage device may include: a main frame which supports at least a region of a user's body; a base frame which is disposed under the main frame and supports the main frame; a tilting frame which is disposed between the main frame and the base frame and is connected to tilting shafts provided at the front of the base frame to extend in the lateral direction; and a tilting means which is disposed between the base frame and the tilting frame and tilts the tilting frame around the tilting shafts.

### TECHNICAL FIELD

The present invention relates to a massage device, more specifically to a massage device capable of forward and backward tilting that is configured to adjust angles of a seat and a backrest so that when a user such as a disabled person or old person stands up from the massage device after the use or when the user sits therein for the use of the massage device, he or she easily stands up or sit with a small force.

### BACKGROUND ART

A massage device is configured to allow a user to get a massage on his or her entire body in a state where he or she sits therein comfortably, and generally, the massage device includes a seat for supporting the user's hips and thighs, a backrest for supporting the user's back, armrests for placing the user's arms thereon, and leg massage parts for placing the user's legs. On the respective parts of the massage device are provided massage modules for massaging the user's spine, hips, thighs, calves, arms, etc., while moving therealong, and air cells (air bags) for pressurizing and massaging the user's body, while repeating expansion and contraction through air supply and discharge.

The backrest, the seat, and the leg massage parts are rotatable relative to one another by means of electric devices or pneumatic devices during massage so that the user can get a massage in a comfortable posture.

However, conventional massage devices are configured to adjust only an angle for performing a reclining function of rotating the seat upward and the backrest downward to allow the user to get a massage in a comfortable posture, and therefore, when an old or disabled person stands up from the massage device after the use, he or she has to stand up with a substantially great force.

To solve such a problem, if the rotational ranges of the seat and the backrest increase, a rotating and driving device for rotating the seat and the backrest becomes complicated in configuration and control.

### PRIOR ART LITERATURE

### Patent Literature

Korean Patent Registration No. 10-1454575 (Issued on Oct. 17, 2014)
Korean Patent Registration No. 10-2111189 (Issued on May 8, 2020)

### DISCLOSURE

### Technical Problem

Accordingly, the present invention has been made in view of the above-mentioned problems occurring in the related art, and it is an object of the present invention to provide a massage device capable of forward and backward tilting that is simplified in configuration, while adjusting angles of a seat and a backrest, so that when a user such as a disabled person or old person stands up from the massage device after the use or when the user sits therein for the use of the massage device, he or she easily stands up or sit with a small force.

### Technical Solution

To accomplish the above-mentioned objects, according to the present invention, there is provided a massage device including: a main frame for supporting at least a region of a user's body; a base frame disposed under the main frame to support the main frame; a tilting frame disposed between the main frame and the base frame in such a way as to be connected to tilting shafts provided at the front of the base frame and extending in a lateral direction; and a tilting means disposed between the base frame and the tilting frame to tilt the tilting frame around the tilting shafts.

### Advantageous Effect

According to the present invention, the massage device is configured to have the seat frame and the backrest frame located above the tilting frame that is disposed rotatable with respect to the base frame and to allow the tilting actuator disposed on the rear end portion of the tilting frame to apply the force to the tilting frame so that the rear portion of the tilting frame is lifted upward to allow the seat frame and the backrest frame to tilt forward, thereby adjusting the seat frame and the backrest to the angle where the user's standing is easily performed.

Accordingly, the massage device according to the present invention is simplified in configuration capable of adjusting the seat frame and the backrest frame to the angle for standing assistive and possible to achieve stable operations for standing assistive.

When the tilting actuator operates to perform the standing assistive mode wherein the tilting frame rotates upward, further, the massage device according to the present invention makes use of the standing assistive means to apply the force for pushing the user's hips forward, thereby increasing the standing assistive force. Accordingly, the user's standing from the massage device is more easily and comfortably performed.

Further, the massage device according to the present invention is configured to have the neck traction module disposed on top of the backrest to pull the user's chin and back neck upward, thereby obtaining the cervical traction effects.

In this case, if the neck traction module operates in the standing assistive state wherein the seat and the backrest are close to the vertical axis, the cervical traction effects may be maximized.

### DESCRIPTION OF DRAWINGS

FIG. 1 is a perspective view showing a massage device according to an embodiment of the present invention.

FIG. 2 is a block diagram showing a configuration of the massage device according to the embodiment of the present invention.

FIG. 3 is a block diagram showing external devices performing communication with the massage device according to the embodiment of the present invention.

FIG. 4 is a perspective view showing a standing assistive function of the massage device according to the embodiment of the present invention.

FIGS. 5A and 5B are perspective views showing a support structure of the massage device according to the embodiment of the present invention.

FIG. 6 shows states of the massage device according to the embodiment of the present invention.

FIG. 7 shows a normal state of the massage device according to the embodiment of the present invention.

FIG. 8 shows a standing assistive state of the massage device according to the embodiment of the present invention.

FIG. 9 shows an example of a standing assistive means of the massage device according to the embodiment of the present invention.

FIG. 10 shows another example of the standing assistive means of the massage device according to the embodiment of the present invention.

FIG. 11 shows the operation of the standing assistive means of FIG. 10.

FIG. 12 shows an example of a standing assistive operation of a controller of the massage device according to the embodiment of the present invention.

FIG. 13 shows another example of the standing assistive operation of the controller of the massage device according to the embodiment of the present invention.

FIG. 14 is a perspective view showing a massage device according to another embodiment of the present invention.

FIG. 15 is a perspective view showing a configuration and an operating example of a neck traction module of the massage device of FIG. 14.

FIG. 16 is a side view showing the configuration and the operating example of the neck traction module of the massage device of FIG. 14.

FIG. 17 is a perspective view showing another example of the neck traction module of the massage device according to another embodiment of the present invention.

FIG. 18 is a front view showing the neck traction module of the massage device of FIG. 17.

FIGS. 19A and 19B are side views showing other examples of the neck traction module of the massage device according to another embodiment of the present invention.

FIG. 20 is a side view showing another example of the neck traction module of the massage device according to the present invention.

FIG. 21 is a side view showing yet another example of the neck traction module of the massage device according to the present invention.

FIG. 22 is a side view showing still another example of the neck traction module of the massage device according to the present invention.

### BEST MODE

The present invention provides a massage device including: a main frame for supporting at least a region of a user's body; a base frame disposed under the main frame to support the main frame; a tilting frame disposed between the main frame and the base frame in such a way as to be connected to tilting shafts provided at the front of the base frame and extending in a lateral direction; and a tilting means disposed between the base frame and the tilting frame to tilt the tilting frame around the tilting shafts.

### MODE FOR INVENTION

A configuration disclosed in the description and the drawings is just a desirable embodiment of the present invention, and therefore, various modifications replacing the embodiment and drawings of the present invention may be provided on the filing date of the present application.

Hereinafter, an explanation of a massage device having a standing assistive function according to embodiments of the present invention will be given in detail with reference to the attached drawings. In the drawings, same reference numerals represent same elements.

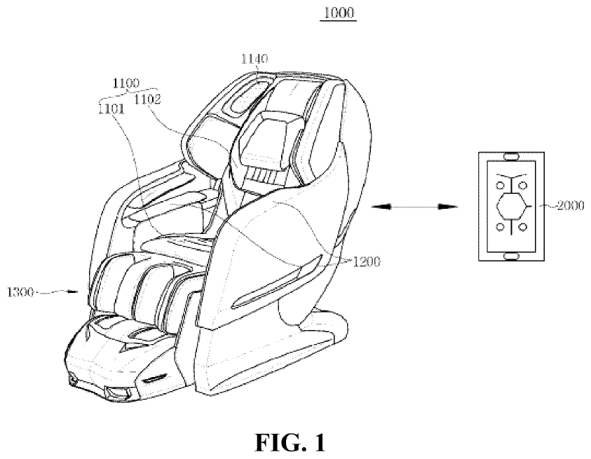

FIG. 1 is a perspective view showing a massage device according to an embodiment of the present invention.

A massage device 1000 according to an embodiment of the present invention includes at least one massage part among a body massage part 1100 providing a given space portion in which at least a region of a user's body is accommodated to massage the user's body (or at least a region of the user's body), arm massage parts 1200 for massaging the user's arms, and leg massage parts 1300 for massaging the user's legs.

The body massage part 1100 is configured to support the user's body in a state of allowing the user to comfortably sit therein and includes a seat 1101 for supporting the user's hips and thighs and a backrest 1102 for supporting the user's back.

The arm massage parts 1200 are located on both sides of the body massage part 1100. That is, the arm massage parts 1200 are located on both sides of the body massage part 1100 to massage both arms of the user. The left side arm massage part 1200 and the right side arm massage part 1200 operate independently of each other under the control of a controller for controlling the massage device 1000.

The leg massage parts 1300 are located on the lower portion of the body massage part 1100 and/or the lower portion of the front side of the massage device 1000. The leg massage parts 1300 are configured to massage both legs of the user. The left side leg massage part 1300 and the right side leg massage part 1300 operate independently of each other under the control of the controller for controlling the massage device 1000.

The body massage part 1100 provides a massage to at least a region of the user's body. For example, the body massage part 1100 massages at least a region of at least one of the user's upper and lower bodies.

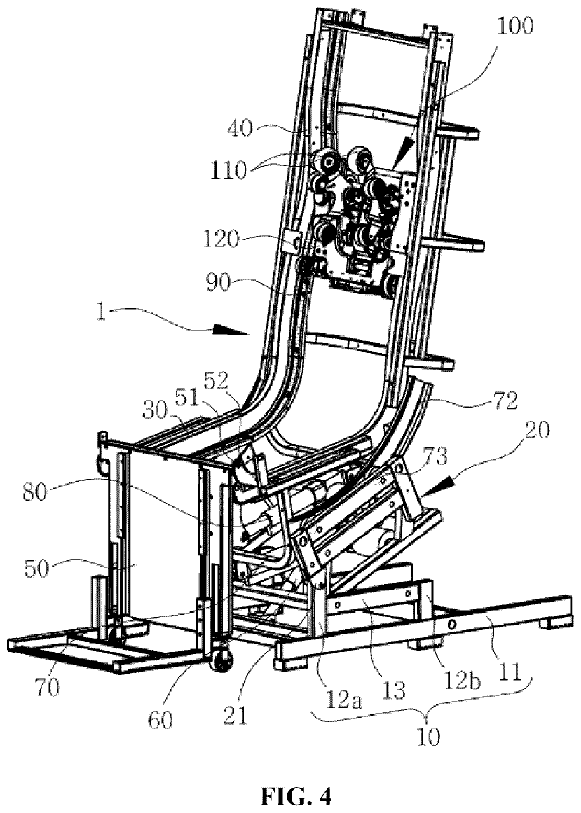

The body massage part 1100 includes a massage module 100 (See FIG. 4) providing a massage function to at least a region of the user's body, an audio output module 1140 providing arbitrary audio outputs to the user, a support structure constituting the frame thereof and supporting the user's body, and a user input part receiving arbitrary inputs from the user.

The components of the body massage part 1100 are included in an exemplary embodiment of the present invention, and further, the body massage part 1100 may have various components not mentioned above.

Further, the shape and configuration of the massage device 1000 as shown in FIG. 1 are just exemplary, and the massage device 1000 according to the present invention may be freely shaped and configured within the scope of the present invention as defined in claims.

The body massage part 1100 provides the given space portion in which at least a region of the user's body is accommodated. The body massage part 1100 has the given space portion corresponding to the shape of the user's body. For example, as shown in FIG. 1, the body massage part 1100 has a sitting type body massage part consisting of the seat 1101 and the backrest 1102 for accommodating the full body of the user or at least a region of the user's body.

A portion of the body massage part 1100 that comes into contact with the floor is made of a given material for increasing a friction force, and otherwise, a given member (e.g., a slip prevention pad) is attached to the portion coming into contact with the floor. Further, casters may be mounted on the portion coming into contact with the floor to ensure the mobility of the massage device 1000.

At least a portion of the body massage part 1100 slidingly moves. For example, if the body massage part 1100 starts to massage, at least a portion of the body massage part 11000 slidingly moves forward. Further, the body massage part 1100 tilts backward. As a result, the body massage part 1100 provides the massage in a state of tilting backward.

According to the embodiment of the present invention, the massage device 1000 includes at least one air cell (not shown). The air cell is located on at least one among portions corresponding to the user's shoulders, portions corresponding to the user's pelvises, the leg massage parts 1300, and the arm massage parts 1200, and of course, the air cell may be located on various positions, without being limited thereto.

The massage device 1000 includes an air supply part, and the air supply part serves to supply air to the air cell so that the air cell is inflated. The air supply part is located inside the body massage part 1100 and/or the leg massage parts 1300. Otherwise, the air supply part may be located on the outside of the massage device 1000.

The leg massage parts 1300 include accommodation spaces in which the user's legs are accommodated and serve to massage at least regions of the user's legs. For example, the leg massage parts 1300 include calf massage parts for massaging the user's calves and foot massage parts for massaging the user's feet.

The leg massage parts 1300 are adjustable in length according to the characteristics of the user's body. For example, if the massage device 1000 is used for a tall user, the lengths of the leg massage parts 1300 have to extend because of the user's long calves. Contrarily, if the massage device 1000 is used for a short user, the lengths of the leg massage parts 1300 have to decrease because of the user's short calves. Accordingly, the leg massage parts 1300 provide leg massage customized to the user's height.

The massage module 100 (See FIG. 4) is disposed inside the body massage part 1100 to provide given dynamic stimulation to the user accommodated in the body massage part 1100. As shown in FIG. 1, the massage module 100 moves along the support structure disposed inside the body massage part 1100.

Rack gears are installed on the frame constituting the support structure of the body massage part 1100 in such a way as to extend from the seat 1101 toward the backrest 1102, and the massage module 100 moves along the rack gears to provide the dynamic stimulation to given regions of the user's body. For example, the massage module 100 serves to tap or press at least one among the back, the shoulders, the waist, the hips, and the thighs. The massage module 100 includes at least one of a ball massage unit and a roller massage unit, but of course, it may not be limited thereto.

According to the embodiment of the present invention, the massage device 1000 includes an audio output module 1140. The audio output module 1140 may be located on various positions. For example, the audio output module 1140 includes a top audio output unit located on top of the seat coming into contact with the user, front audio output units attached to the front ends of the arm massage parts on the left and right sides of the seat and, and/or rear audio output units attached to the rear ends of the arm massage parts, but of course, the audio output module 1140 may not be limited thereto. In this case, the audio output module 1140 provides surround sound such as 5.1 channel, but of course, it may not be limited thereto.

According to the embodiment of the present invention, the massage device 1000 is controlled by a massage device control device 2000. The massage device control device 2000 is connected to the massage device 1000 through wired communication and/or wireless communication.

The massage device control device 2000 includes at least one user's personal device among a remote controller, a cellular phone, and a personal digital assistant (PDA), but it may include various electronic devices connectable with the massage device 1000 through the wired communication or wireless communication, without being limited thereto.

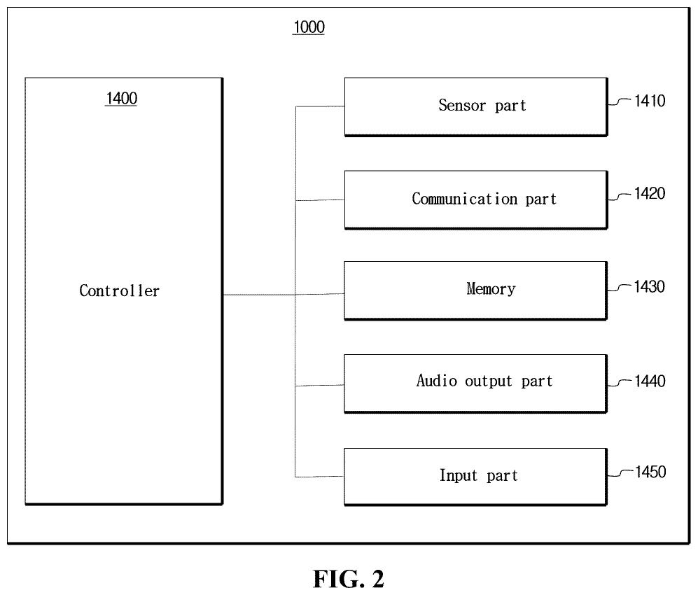

Referring to FIG. 2, the massage device 1000 according to the embodiment of the present invention includes at least one among a controller 1400, a sensor part 1410, a communication part 1420, a memory 1430, an audio output part 1440, and an input part 1450. The controller 1400 includes at least a processor and a memory. At least one processor executes the commands stored in the memory.

The controller 1400 serves to control the massage device 1000. The controller 1400 may include one processor or a plurality of processors. If the controller 1400 includes the plurality of processors, some of the plurality of processors may be physically spaced apart from one another. Further, the massage device 1000 may operate in various ways, without being limited thereto.

According to the embodiment of the present invention, the controller 1400 controls the operations of the massage device 1000. For example, the massage device 1000 has a plurality of actuators, and the controller 1400 controls the operations of the plurality of actuators, thereby controlling the operations of the massage device 1000. For example, the massage device 1000 includes at least one among drivers for moving armrest frame supports, at least one actuator of the massage module 100, a back angle actuator, leg angle actuators, foot massage actuators, leg length adjusting actuators, and a sliding actuator, and they are controlled by the controller 1400, so that the operations of the massage device 1000 are controlled. In this case, at least one actuator of the massage module 100 includes one of various actuators such as a moving actuator, a tilting actuator, and a massaging actuator.

The moving actuator is an actuator that enables upward and downward movements of the massage module 100 and moves along the support structure in at least one direction of upward and downward directions of the massage device 1000. Through the operation of the moving actuator of the massage module 100, the massage module 100 moves along the rack gears. The tilting actuator serves to tilt the massage module 100 in at least one direction of forward and backward directions of the massage module 100. That is, the massage module 100 tilts in at least one direction of forward and backward directions thereof through the tilting actuator. The massaging actuator serves to move the massage module 100 freely to provide various massage actions to the user.

The controller 1400 operates at least one actuator of the massage module 100 to provide various massage operations. For example, the controller 1400 operates at least one actuator of the massage module 100 to provide tapping, pressing, and the like, but without being limited thereto, of course, the controller 1400 may provide various massage operations.

The back angle actuator is an actuator for adjusting an angle of a portion of the massage device 1000 with which the user's back is brought into contact, and through the operation of the back angle actuator, the back angle of the massage device 1000 is adjustable.

The leg angle actuators are actuators for adjusting angles of the leg massage parts 1300 of the massage device 1000, and through the operations of the leg angle actuators, angles between the leg massage parts 1300 and the body massage part 1100 are adjustable.

The foot massage actuators are actuators for operating the foot massage modules of the leg massage parts 1300. Through the foot massage actuators, the massage device 1000 provides foot massage to the user.

The leg length adjusting actuators are actuators for adjusting the lengths of the leg massage parts 1300. For example, the controller 1400 allows the lengths of the leg massage parts 1300 to be customized to the user's leg lengths through the leg length adjusting actuators, so that the massage customized to the user's body shape is provided to the user.

The memory 1430 is included in the controller 1400 or located on the outside of the controller 1400. The memory 1430 stores various information related to the massage device 1000. For example, the memory 1430 stores massage control information, user information, etc., but it may not be limited thereto. The user information includes various information related to the user, such as personal authentication information, user bio-information (e.g., age, height, weight, blood pressure, body composition, heart rate, electrocardiogram, etc.), and the like.

The memory 1430 includes a non-volatile storage medium that consistently stores arbitrary data. For example, the memory 1430 includes a storage device such as a disc, an optical disc, a magneto-optical disc as well as a storage device based on a flash memory and/or a battery-backup memory, but it may not be limited thereto.

The memory 1430 may represent a volatile storage device, such as random access memory (RAM), dynamic RAM (DRAM), static RAM (SRAM), that is a main storage device to which the processor is directly accessed and loses stored data if power is turned off, but the memory 1430 may not be limited thereto. The memory 1430 is operated by the controller 1400.

The massage device 1000 includes the sensor part 1410. The sensor part 1410 acquires various information using at least one or more sensors. The sensor part 1410 include sensors using pressure, potential, and optical measuring means. For example, the sensors include pressure sensors, infrared sensors, LED sensors, touch sensors, electrode sensors, air pressure measuring sensors, etc., but they may not be limited thereto.

Further, the sensor part 1410 includes bio-information acquiring sensors. The bio-information acquiring sensors include at least one among fingerprint information, face information, voice information, iris information, weight information, blood pressure information, heart rate information, electrocardiogram information, and body composition information, but without being limited thereto, of course, they may include various bio-information. For example, the massage device 1000 provides customized massage according to the information acquired through the sensors.

The communication part 1420 receives signals from external devices or transmits signals generated from the massage device 1000 to the external devices.

For example, the controller 1400 processes the received signals through the communication part 1420, acquires processed result signals, and transmits the result signals to the communication part 1420. The communication part 1420 transmits (outputs) the result signals to the external devices.

The controller 1400 acquires information (e.g., information of the massage module 100, information of the arm massage parts 1200, etc.) of various components of the massage device 1000 and transmits the information to the communication part 1420. The communication part 1420 transmits the information of the massage device 1000 to the external devices.

The communication part 1420 performs communication with the modules inside the massage device 1000, external massage devices, and/or the user terminal through arbitrary networks. The communication part 1420 includes wired/wireless connection modules for network access. For example, wireless connection technologies include wireless LAN (WLAN), Wi-Fi, Wireless broadband (Wibro), World interoperability for microwave access (Wimax), high speed downlink packet access (HSDPA), etc. For example, wired connection technologies include X digital subscriber line (XDSL), fibers to the home (FTTH), power line communication (PLC), etc. Further, the communication part 1420 includes a short range communication module to transmit and receive data to and from an arbitrary device/terminal located in a short range. For example, the short range communication technologies include Bluetooth, radio frequency identification (RFID), infrared data association (IrDA), ultra-wideband (UWB), ZigBee, etc., but they may not be limited thereto.

The massage device 1000 includes the input part 1450 and/or output part. The massage device 1000 receives the user's inputs through the input part 1450. The massage device 1000 outputs the processed results of the controller 1400 through the output part.

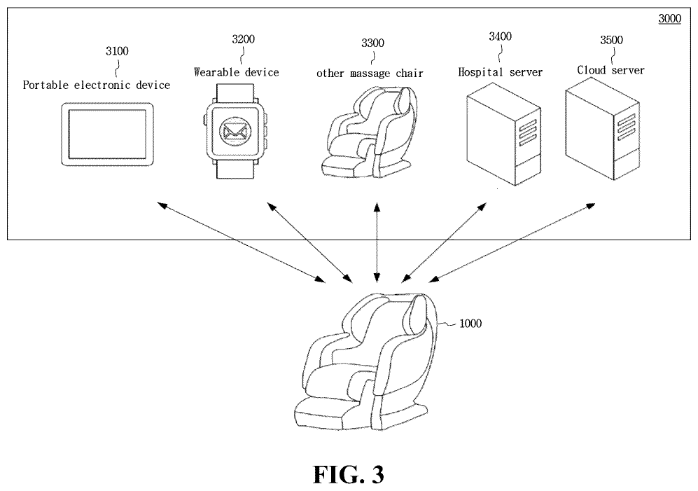

In detail, the input part 1450 receives the commands related to the operation control of the massage device 1000 from the user, and in this case, the input part 1450 may be provided to various forms. For example, the input part 1450 is located on the body massage part 110 or one side leg massage part 1300, but of course, it may not be limited thereto. The input part 1450 includes the user input part 1160 and the massage device control device 2000 as shown in FIG. 1 or various external devices as will be discussed later with reference to FIG. 3.

The massage device 1000 acquires various commands from the user through the input part 1450. For example, the massage device 1000 receives arbitrary commands related to massage module selection, massage type selection, massage intensity selection, massage time selection, selection of region to be massaged, body massage part position and operation selection, massage device power on/off selection, heating function operation selection, sound reproducing selection, etc., but it may not be limited thereto.

The massage device 1000 provides an interface through which massage modes are selected. For example, the input part 1450 or the output part includes the massage device control device 2000. Through the massage device control device 2000, a medical massage list having various modes related to body improvement is provided.

The medical massage modes include at least one among a concentration power mode, a meditation mode, a recovering mode, a stretching mode, a sleep mode, an energy mode, a golf mode, a hip-up mode, an examinee mode, a weightless mode, a growth mode, and a cervical traction mode.

According to another embodiment of the present invention, the input part 1450 includes hot key buttons and/or selection buttons for executing direction selection, cancelling, and inputting according to predetermined user setting functions or predetermined functions in itself.

The input part 1450 is provided to the form of a touchscreen, a keypad, a dome switch, a touch pad (static pressure/static electricity), a jog dial, a jog switch, etc., but it may not be limited thereto. Further, the input part 1450 acquires the commands through the user's utterance, based on a voice recognition technology.

The output part includes a display for displaying operating situations of the massage device 1000 or the current state of the user. In this case, the display includes at least one among a liquid crystal display (LCD), a thin film transistor-liquid crystal display (TFT LCD), an organic light-emitting diode (OLED), a flexible display, a 3D display, but of course, it may not be limited thereto.

The output part includes the audio output part 1440. The audio output part 1440 of FIG. 2 includes the audio output module 1140 of FIG. 1. The audio output part 1440 provides given audio outputs to the user. For example, the audio output part 1440 outputs sound sources and/or binaural beats optimized to massage patterns provided by the massage device 1000, thereby allowing the user's brain to be stimulated. The audio output part 1440 outputs the sound signals received from a network (not shown) or stored in internal/external storage media (not shown). For example, the audio output part 1440 outputs the sound sources generated according to the control of the user terminal through the network connection (e.g., Bluetooth connection) to the user terminal. Further, the audio output part 1440 outputs given sound signals generated according to the operations of the massage device 1000.

A person of ordinary skill in the art will know and appreciate that the present invention is implemented by connecting other program modules and/or by combining hardware and software. For example, the present invention is implemented by a computer-readable medium.

A computer-accessible medium may be a computer-readable medium, and the computer-readable medium may include volatile and non-volatile medium, transitory and non-transitory medium, and removable and non-removable medium. For example, the computer-readable medium includes a computer-readable storage medium and a computer-readable transmission medium.

The computer-readable storage medium may include volatile and non-volatile storage medium, transitory and non-transitory storage medium, and removable and non-removable storage medium that are implemented by arbitrary methods or technologies where a computer-readable command, a data structure, a program module, or other data information and the like are stored. The computer-readable storage medium may include RAM, ROM, EEPROM, a flash memory or other memory technologies, an optical storage medium such as CD-ROM and a digital video disk (DVD), a magnetic disc storage device or other magnetic storage devices, or arbitrary medium accessible by a computer to store desired information, but of course, it may not be limited thereto.

FIG. 3 is a block diagram showing external devices performing communication with the massage device 1000 according to the embodiment of the present invention.

The massage device 1000 performs the communication with external devices 3000 through the communication part 1420 wiredly or wirelessly and transmits and receives various data to and from the external devices 3000.

The external devices 3000 include a portable electronic device 3100 such as an AI speaker, a tablet, or a smartphone. The portable electronic device 3100 is used only for the massage device 1000 or a general portable electronic device. Further, the external devices 3000 include a wearable device 3200 such as a smartwatch or smartband. The external devices 3000 include another massage device 3300 which is not the massage device 1000 used now. The external devices 3000 include a personal health record (PHR) server 3400. Further, the external devices 3000 include a cloud server 3500. The external devices 3000 include a medical measurement device such as an electronic scale, a blood sugar measuring instrument, or a blood pressure measuring instrument.

According to the present invention, some examples of the external devices 3000 have been explained, but devices having communication with the massage device 1000 wiredly or wirelessly to transmit and receive information to and from the massage device 1000 will be included in the external devices 3000.

According to the embodiment of the present invention, the massage device 1000 has a reclining function through which the user gets a massage in a comfortable posture. The reclining function is used to rotate the seat 1101 and the backrest 1102 backward from their reference positions so that the user lies down on them.

According to the embodiment of the present invention, the massage device 1000 has a standing assistive function of helping the user's standing operation. The standing assistive function is used to tilt (or rotate) the seat 1101 and the backrest 1102 forward from their reference positions by given angles so that the seat 1101 and the backrest 1102 are located close to a vertical axis, thereby allowing the massage device 1000 to be adjusted to an angle at which the user easily stands up. Through the standing assistive function, the user can easily stand up even with a small force if he or she desires to stand up from the massage device 1000 after the use of the massage device 1000 has been completed.

FIGS. 4 to 11 show the standing assistive function of the massage device 1000.

Referring to FIGS. 4 to 11, the massage device 1000 includes the support structure, a standing assistive part, and a reclining means.

The support structure is a structure constituting the seat 1101, the backrest 1102, and the leg massage parts 1300 and made with at least one of a frame and a plate.

The support structure serves to support the various components of the massage device 1000 as well as the user's body. In this case, the various components include at least one or more among the massage module 100, the air cell, at least one actuator of the massage module 100, the air supply part for supplying air to the air cell and discharging the air from the air cell to expand or contract the air cell, a reclining angle adjusting part, the standing assistive part, and the controller 1400 (See FIG. 2).

The support structure is covered with a molded product having the corresponding shape to the body to support the user's body comfortably and an interior material such as urethane foam, sponge, or foamed polystyrene, and the interior material is covered with an exterior cover such as polyester tricot fabric with fleece, synthetic leather, or natural leather.

Hereinafter, the support structure will be explained in detail.

According to an embodiment of the present disclosure, the support structure includes a main frame 1, a base frame 10, a tilting frame 20, tilting shafts 21, and rack gears 90.

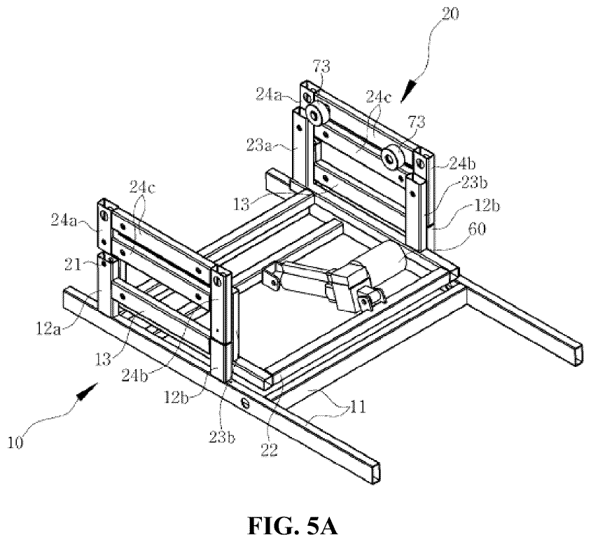

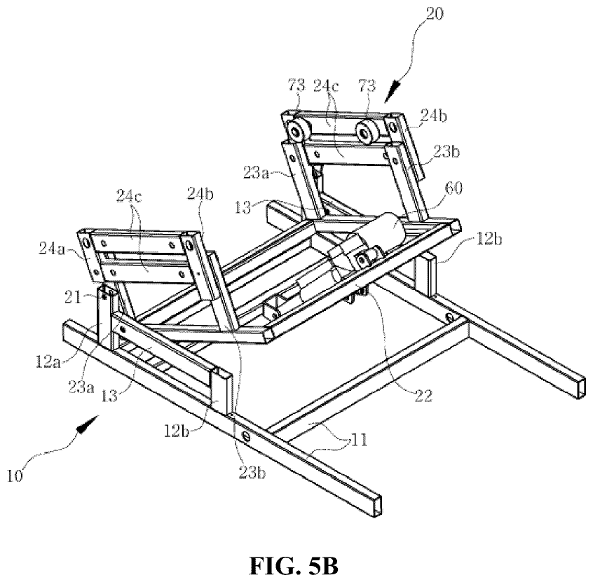

As shown in FIGS. 4, 5A and 5B, the main frame 1 supports at least a region of the user's body. For example, the main frame 1 includes a seat frame 30 and a backrest frame 40. The seat frame 30 supports at least a region of the user's lower body. The backrest frame 40 supports at least a region of the user's upper body.

The base frame 10 is placed on the floor to support the entire massage device 1000. For example, the base frame 10 is located under the main frame 1 to support the main frame 1.

The base frame 10 includes a plurality of horizontal base frames 11, a plurality of vertical base frames 12, and reinforcing frames 13.

The plurality of horizontal base frames 11 extend in forward and backward directions and in left and right directions and are placed on the floor.

The plurality of vertical base frames 12 are disposed on both front sides and rear sides of the horizontal base frames 11 in such a way as to extend in a first direction. In this case, the first direction is an upward direction of the base frame 10 (or the upward direction of the horizontal base frames 11). For example, the plurality of vertical base frames 12 are located vertically to the plurality of horizontal base frames 11.

The plurality of vertical base frames 12 include front side vertical base frames 12a located on both front sides of the horizontal base frames 11 and rear side vertical base frames 12b located on both rear sides of the horizontal base frames 11. The front side vertical base frames 12a and the rear side vertical base frames 12b are located vertically to the horizontal base frames 11.

The reinforcing frames 13 connect the front side vertical base frames 12a and the rear side vertical base frames 12b. For example, the reinforcing frames 13 connect the upper portions of the front side vertical base frames 12a and the upper portions of the rear side vertical base frames 12b. That is, the reinforcing frames 13 connect at least regions between the upper and lower portions of the front side vertical base frames 12a and the upper portions of the rear side vertical base frames 12b. In this case, at least regions between the upper and lower portions of the front side vertical base frames 12 are intermediate portions of the front side vertical base frames 12.

The tilting frame 20 is located between the main frame 1 and the base frame 10 to support the main frame 1. For example, the tilting frame 20 is connected to the tilting shafts 21 that are disposed on the front side of the base frame 10 and extend in a lateral direction. In this case, the tilting shafts 21 are disposed on top side of the front side of the base frame 10 (e.g., top ends of the front side vertical base frames 12a) in such a way as to extend in the lateral direction.

The front side of the tilting frame 20 is rotatable up and down around the tilting shafts 21, and accordingly, the tilting frame 20 is tilted (rotated) with respect to the base frame 10 by means of a standing assistive tilting means.

For example, the tilting frame 20 has the shape of a general cuboid and rotatably supports the seat frame 30 and the backrest frame 40 on the base frame 10. The lower end portions of both front sides of the tilting frame 20 are connected to the tilting shafts 21 and thus rotatable up and down around the tilting shafts 21, thereby performing a function of adjusting a standing assistive angle of the seat frame 30 and the backrest frame 40.

Referring to FIGS. 5A and 5B, the tilting frame 20 includes a horizontal tilting frame 22, a plurality of vertical tilting frames 23a and 23b, and reinforcing tilting frames 24a, 24b, and 24c.

The horizontal tilting frame 22 is provided to the shape of a square frame extending in forward and backward directions and in left and right directions between both side vertical base frames 12 and the reinforcing frames 13. In this case, the rear end portion of the horizontal tilting frame 22 is connected to a tilting actuator 60 as the standing assistive tilting means so that the horizontal tilting frame 22 receives an external force from the tilting actuator 60.

The plurality of vertical tilting frames 23a and 23b are located on both front and rear sides of the horizontal tilting frame 22 in a second direction. In this case, the second direction is a downward direction of the tilting frame 20 (or the upward direction of the horizontal tilting frame 22). For example, the plurality of vertical tilting frames 23a and 23b are located vertically to the plurality of horizontal tilting frame 22. Further, the front side vertical tilting frames 23a and the rear side vertical tilting frames 23b are overlaid on the lateral (left and right) inner surfaces of the front side vertical base frames 12a and the rear side vertical base frames 12b.

At least regions between the upper and lower portions of the front side vertical tilting frames 23a of the plurality of vertical tilting frames 23a and 23b are rotatably connected to the upper portions of the front side vertical base frames 12a by means of the tilting shafts 21. In this case, at least regions between the upper and lower portions of the front side vertical tilting frames 23a are intermediate portions of the front side vertical tilting frames 23a.

The reinforcing tilting frames 24a, 24b, and 24c serve to connect the front side vertical tilting frames 23a and the rear side vertical tilting frames 23b to reinforce the strength of the tilting frame 20.

For example, the reinforcing tilting frames 24a, 24b, and 24c include the front side vertical reinforcing tilting frames 24a disposed (or coupled) on the outer surfaces of the front side vertical tilting frames 23a, the rear side vertical reinforcing tilting frames 24b disposed on the outer surfaces of the rear side vertical tilting frames 23b, and the horizontal reinforcing tilting frames 24c connecting the front side vertical reinforcing tilting frames 24a and the rear side vertical reinforcing tilting frames 24b.

The front side vertical reinforcing tilting frames 24a and the rear side vertical reinforcing tilting frames 24b are located on the same line as the front side vertical base frames 12a and the rear side vertical base frames 12b. The lower end portions of the rear side vertical reinforcing tilting frames 24b are supportedly seated onto the upper end portions of the rear side vertical base frames 12b, thereby functioning as stoppers and increasing support forces thereof. In this case, the lengths of the front side vertical reinforcing tilting frames 24a are shorter than those of the rear side vertical reinforcing tilting frames 24b, and the lengths of the front side vertical base frames 12a are longer than those of the rear side vertical base frames 12b, so that the tilting shafts 21 are located at higher positions than tops of the rear side vertical base frames 12b. Even if a driving force of the tilting actuator 60 is low, accordingly, a high tilting force is obtained.

In the case where the lower end portions of the rear side vertical reinforcing tilting frames 24b are connectably seated onto the upper end portions of the rear side vertical base frames 12b, buffering materials (not shown) made of an elastic material such as rubber, silicone, and the like are located between the lower end portions of the rear side vertical reinforcing tilting frames 24b and the upper end portions of the rear side vertical base frames 12b, thereby absorbing impacts generated therebetween.

The horizontal reinforcing tilting frames 24c include upper side horizontal reinforcing tilting frames and lower side horizontal reinforcing tilting frames. The upper side horizontal reinforcing tilting frames connect the upper portions of the front side vertical reinforcing tilting frames 24a and the upper portions of the rear side vertical reinforcing tilting frames 24b. The lower side horizontal reinforcing tilting frames connect at least regions of the front side vertical reinforcing tilting frames 24a and at least regions of the rear side vertical reinforcing tilting frames 24b. For example, one end of the lower side horizontal reinforcing tilting frames is connected to the lower portions of the front side vertical reinforcing tilting frames 24a, and the other end thereof is connected to the intermediate portions of the rear side vertical reinforcing tilting frames 24b.

A plurality of reclining rollers 73 are rotatably disposed on the inner surfaces of the upper side horizontal reinforcing tilting frames 24c in such a way as to be guided along reclining rails 72 located on both sides of the seat frame 30.

The tilting frame 20 having such a configuration advantageously provides the standing assistive function and the reclining function, without increasing the total size of the massage device 1000, especially the left and right width of the massage device 1000.

Under such a configuration of the tilting frame 20, the tilting shafts 21 are high in position, and even with the application of a low driving force, a high tilting force is generated.

The tilting frame 20 rotates up and down around the tilting shafts 21 by means of the standing assistive tilting means located on the lower portion thereof. For example, the standing assistive tilting means is located between the base frame 10 and the tilting frame 20 to tilt the tilting frame 20 around the tilting shafts 21. In detail, one end of the standing assistive tilting means is connected to the front side (e.g., the front side horizontal base frame among the plurality of horizontal base frames 11) of the base frame 10, and the other end thereof to the rear side (e.g., the rear end of the horizontal tilting frame 22) of the tilting frame 20.

The standing assistive tilting means tilts the tilting frame 20 around the tilting shafts 21 through the adjustment of the length between one end and the other end thereof. In this case, the standing assistive tilting means is the tilting actuator 60.

The seat frame 30 is rotatably disposed on top of the tilting frame 20 to support the user's hips.

The backrest frame 40 is located on the rear end portion of the seat frame 30 in such a way as to extend upward to support the user's back.

The seat frame 30 is a frame for the seat 1101, and the backrest frame 40 is a frame for the backrest 1102. The seat frame 30 is connected integrally with the backrest frame 40.

As mentioned above, the seat frame 30 and the backrest frame 40 are formed integrally with each other in such a way as to rotate together, but they may not be limited thereto. For example, the seat frame 30 and the backrest frame 40 are rotatably connected relative to each other so that they are physically distinguished from each other.

The rack gears 90 are members that engage with pinion gears of the massage module 100 to generate driving forces for upward and downward movements of the massage module 100, and they are located on the seat frame 30 and the backrest frame 40. The seat frame 30 and the backrest frame 40 have rails located just above the rack gears 90 in parallel with the rack gears 90 to guide the upward and downward movements of the massage module 100. The rack gears 90 are made of metal or plastic materials. For example, the rack gears 90 are made of iron, steel, alloys, reinforced plastics, melamine resin, phenol resin, etc., but they may not be limited thereto. Further, in the case where the seat frame 30 and the backrest frame 40 are rotatably connected relative to each other, the rack gears 90 are made of flexible materials so that they are flexibly deformed according to the changes in the angle between the seat frame 30 and the backrest frame 40.

According to the embodiment of the present invention, the rack gears 90 face each other on both sides of the seat frame 30 and the backrest frame 40, and the massage module 100 moves along the rack gears 90. As shown in FIG. 4, the rack gears 90 are located in upward and downward directions, but they may not be limited thereto. The rack gears 90 may have forward and backward rack gears and upward and downward rack gears. According to the present invention, the forward and backward direction represents the direction from the massage module 100 toward the user or from the user toward the massage module 100, which is called the direction of Z-axis.

The massage module 100 includes gears engaging with the rack gears 90. In detail, the massage module 100 includes a plurality of gears engaging with the forward and backward rack gears and the upward and downward rack gears. As the gears rotate by means of the actuators of the massage module 100, the massage module 100 tilts (or rotates) in at least one direction of the forward and backward directions thereof, and as the massage module 100 moves forward, the intensity of the massage becomes high. Contrarily, as the massage module 100 moves backward, the intensity of the massage becomes low.

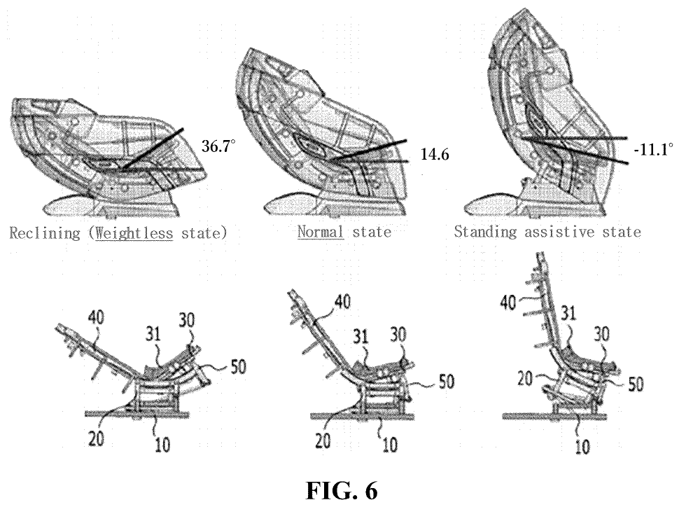

As shown in FIG. 6, if the massage device 1000 is in a normal state, the seat frame 30 and the backrest frame 40 are slant backward to a given angle. In the normal state, for example, the seat frame 30 is lifted upward therefrom by about 14 to 150 with respect to a horizontal axis to the floor. Accordingly, the user gets a massage in a state of comfortably sitting in the massage device 1000.

Since the seat frame 30 and the backrest frame 40 are slant backward to the given angle, in this case, the user should stand up with a great force if he or she desires to stand up from the massage device 1000 after the use of the massage device 1000.

To solve such a problem, the massage device 1000 executes a standing assistive mode (or standing assistive function) through the standing assistive part, and as shown in the right portion of FIG. 6, the state of the massage device 1000 is changed to a standing assistive state.

If the user desires to stand up from the massage device 1000 after the use of the massage device 1000, the standing assistive part helps the user's standing operation so that he or she stands up from the massage device 1000 with a small force.

Hereinafter, the standing assistive part will be explained in detail.

According to an embodiment of the present disclosure, the standing assistive part includes at least one of the standing assistive tilting means and a standing assistive means.

The standing assistive tilting means is located on the lower portion of the support structure to tilt the support structure in at least one direction of the forward (or upward) direction and the backward (or downward) direction around the tilting shafts 21 located on the front side of the support structure under the control of the controller 1400 (See FIG. 2).

For example, the standing assistive tilting means is the tilting actuator 60. The front end portion of the tilting actuator 60 is hinge-coupled to the front side of the base frame 10, and the rear end portion thereof to the underside of the rear end portion of the tilting frame 20. The tilting actuator 60 is an electric actuator having an operating rod 61. The tilting actuator 60 receives power from a motor operating with the power applied from the control device of the massage device 1000 and linearly reciprocates in such a way as to be expanded and contracted.

As mentioned above, the tilting actuator 60 is the electric actuator operated by the motor, but it may not be limited thereto. For example, the tilting actuator 60 may be a hydraulic actuator having an operating rod expanded and contracted by the pressure of a fluid (e.g., air) supplied from a hydraulic supply device (not shown).

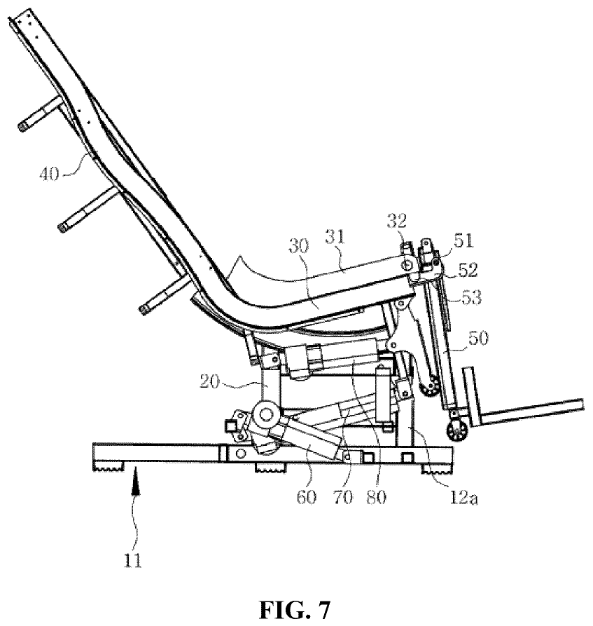

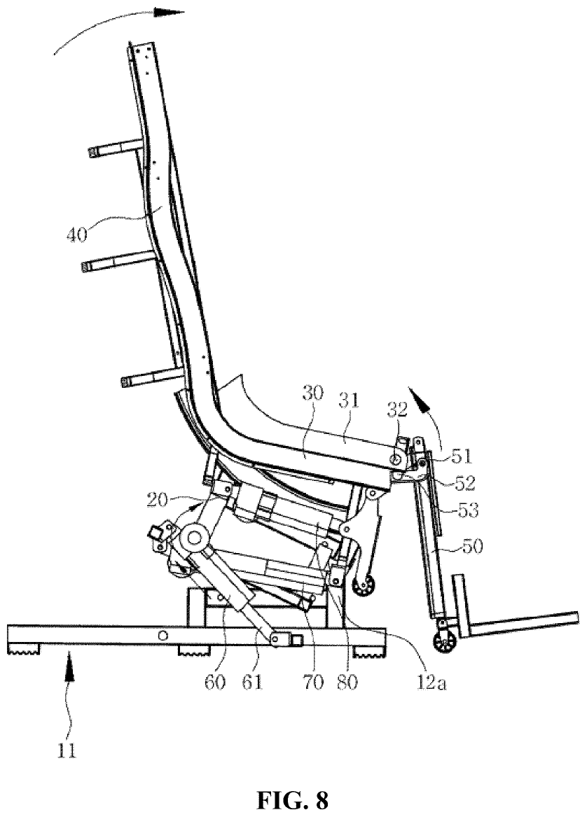

For example, in the case where the standing assistive mode is executed, the controller 1400 operates the standing assistive tilting means to change the normal state (as shown in the middle portion of FIG. 6 and as shown in FIG. 7) of the massage device 1000 into the standing assistive state as shown in the right portion of FIG. 6 and as shown in FIG. 8, thereby helping the user who desires to stand up from the massage device 1000. The standing assistive state represents that the seat frame 30 is descended by about 10° with respect to the horizontal axis to the floor and the backrest frame 40 rotates forward in such a way as to be close to a vertical shaft thereto.

For example, after the use of the massage device 1000 has been completed, the user executes the standing assistive mode of the massage device 1000 through a command input part of the massage device 1000 or an application only for the massage device 1000 of the smartphone. If the standing assistive mode is executed, the controller 1400 operates the motor of the tilting actuator 60 to expand the operating rod 61, so that the tilting frame 20 rotates in the forward direction (or in the upward direction, that is, in a clockwise direction in the drawings) around the tilting shafts 21. That is, as shown in FIGS. 6 and 8, the controller 1400 changes the normal state (as shown in the middle portion of FIG. 6 and as shown in FIG. 7) of the massage device 1000 into the standing assistive state.

As a result, the controller 1400 provides a standing assistive force for pushing the user's body forward to the user through the change in the angle of the tilting frame 20, so that the user takes a posture of standing up forward, thereby allowing him or her to stand up easily from the massage device 1000 with a small force.

For another example, the controller 1400 operates the standing assistive tilting means to change the standing assistive state of the massage device 1000 as shown in FIG. 8 into the normal state as shown in FIG. 7, thereby helping the user who desires to sit in the massage device 1000.

For example, the controller 1400 operates the motor of the tilting actuator 60 to contract the operating rod 61, so that the tilting frame 20 rotates in the backward direction (or in the downward direction, that is, in a counterclockwise direction in the drawings) around the tilting shafts 21. That is, the controller 1400 tilts the tilting frame 20 backward to allow the tilting frame 20 to be returned to its initial position (or normal state) before the tilting, thereby helping the user who desires to sit in the massage device 1000.

That is, the standing assistive tilting means tilts the support structure in the forward direction of the support structure to help the user's standing and tilts the support structure in the backward direction of the support structure to help the user's sitting.

As mentioned above, the massage device 1000 changes the state thereof through the standing assistive tilting means to help the user who desires to stand up therefrom, but it may not be limited thereto. For example, the massage device 1000 may help the user's standing through the standing assistive means as well as the standing assistive tilting means.

For example, the controller 1400 directly applies a force for pushing the user's body in the forward direction of the support structure to the user's body through the standing assistive means, thereby allowing the user to more easily stand up in the standing assistive mode. That is, the standing assistive means serves to apply the force for pushing the user's body, especially the user's hips in the forward and upward direction of the massage device 1000 in the standing assistive mode, thereby allowing the user's standing to be more easily performed.

According to an embodiment of the present disclosure, the standing assistive means includes at least one among a seat plate 31, a seat lifting unit, and the massage module 100.

For example, the standing assistive means consists of the seat plate 31 and the seat lifting unit, and through the seat plate 31 and the seat lifting unit, an additional standing assistive force increasing the standing assistive force is provided to the user.

The seat plate 31 is located on top of the seat frame 30 to support the user's lower body (or hips).

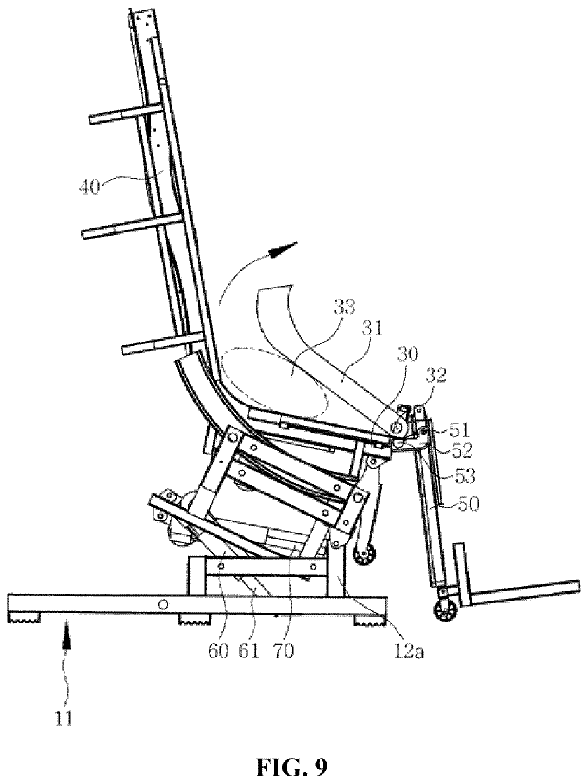

For example, the seat plate 31 has a structure having a solid shape corresponding to the user's hips to allow the user's hips (e.g., the hips and thighs) to be supportedly seated thereon when the user sits on the seat 1101 of the massage device 1000. The seat plate 31 has a seat hinge shaft 32 located on the front side thereof in such a way as to extend in a lateral direction. As shown in FIG. 9, the front side of the seat frame 31 is rotatable up and down (in the forward and backward directions of the massage device 1000) around the seat hinge shaft 32 by means of the seat lifting unit. For example, the seat plate 31 is tilted and lifted in the upward (forward) direction thereof around the seat hinge shaft 32. The seat plate 31 is tilted and descended in the downward (backward) direction thereof around the seat hinge shaft 32 in the state of being lifted.

The seat lifting unit is located between the seat frame 30 and the underside of the seat plate 31. The seat lifting unit tilts (or rotates) the seat plate 31 in at least one direction of the upward and downward directions of the seat plate 31.

For example, the seat lifting unit tilts the seat plate 31 in the upward direction of the seat plate 31 to lift the seat plate 31 in the upward direction of the seat plate 31. The seat lifting unit tilts the lifted seat plate 31 in the downward direction of the seat plate 31 to descend the seat plate 31 in the downward direction of the seat plate 31.

The seat lifting unit consists of a lifting airbag (or lifting air cell 33). For example, the lifting airbag 33 is expanded by the pressure of air supplied from the outside thereof to pressurize the seat plate 31 in the upward direction of the seat plate 31, thereby lifting the seat plate 31. The expanded lifting airbag 33 is contracted, as the expanded air is discharged, to descend the seat plate 31 in the downward direction of the seat plate 31.

According to an embodiment of the present invention, when the tilting frame 20 rotates upward to allow the user's body (the upper body) to move forward by means of the operation of the tilting actuator 60 in the standing assistive mode, the massage device 1000 supplies the air to the lifting airbag 33 to expand the lifting airbag 33, so that the seat plate 31 rotates upward around the seat hinge shaft 32 (or the seat plate 31 is lifted around the seat hinge shaft 32 in the upward direction thereof). In this case, the hips of the user are pushed forward and upward to increase the standing assistive force, thereby allowing the user to stand up easily with a small force.

As mentioned above, the seat lifting unit is the lifting airbag 33, but it may not be limited thereto. For example, the seat lifting unit may consist of various devices such as a motor providing a rotary force and an actuator expanded and contracted by the motor. If the seat lifting unit is the motor, it is located on the seat hinge shaft 32, and through the rotary force of the motor, the seat plate 31 is lifted or descended.

As a result, the massage device 1000 provides the additional standing assistive force that increases the standing assistive force through the standing assistive means in the standing assistive mode to the user, so that the user stands up easily with a smaller force than the user's force needed when he or she stands up with the standing assistive force.

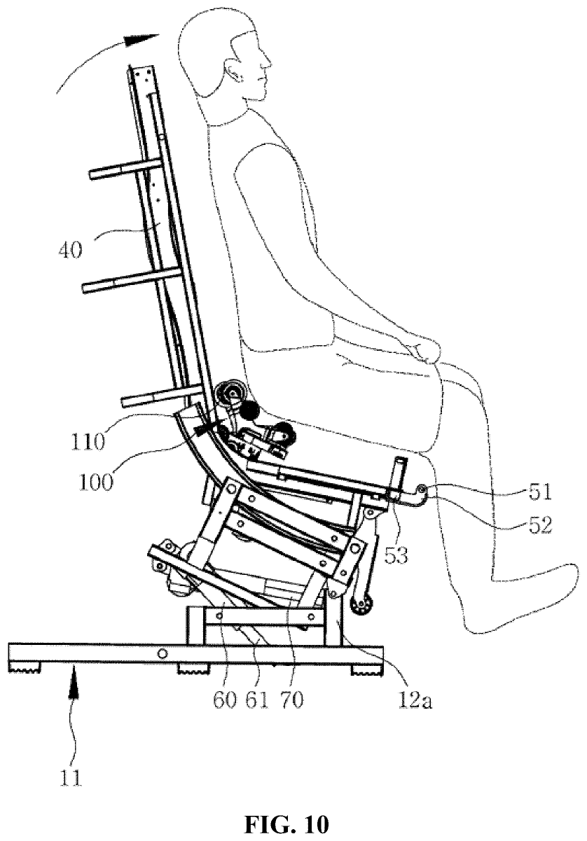

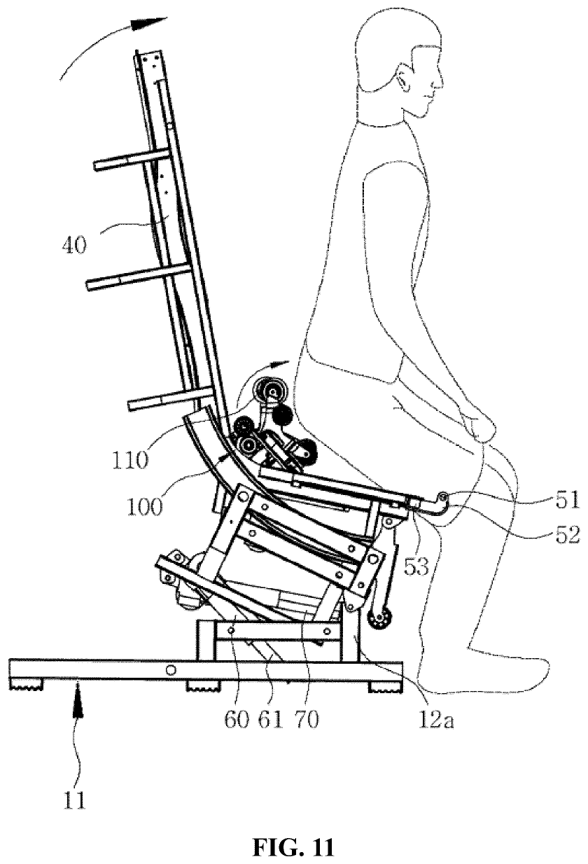

For another example, as shown in FIGS. 10 and 11, the standing assistive means consists of the massage module 100, unlike the above-mentioned standing assistive means as the seat lifting unit, and through the massage module 100, the additional standing assistive force that increases the standing assistive force is provided to the user.

For example, the massage module 100 includes a plurality of massagers 110 and a moving part 120 (See FIG. 4).

Like the massage module of the general massage device, the massage module 100 has the plurality of massagers 110 adapted to vibrate and/or rotate in forward and backward directions and in left and right directions through a motor (not shown) to perform a massage on the user's back, hips, and thighs.

The moving part 120 moves the massage module 100 along the rack gears 90. The massage module 100 is located on the front surface of the moving part 120.

In the case where a massage mode is executed, the massage module 100 moves along the support structure to provide the massage on at least a region of the user's body through the massagers 110. The massage mode is a mode in which the user's body is massaged according to the user's input command.

In the case where the standing assistive mode is executed, the massage module 100 moves the region corresponding to the user's lower body on the entire region of the support structure (or the entire region of the rack gears 90) and tilts in the forward direction thereof. As a result, the massage module 100 provides the force for pushing the user's body on the user's hip regions as the user's lower body forward to the user.

For example, the controller 1400 moves the massage module 100 to the region corresponding to the user's lower body. The controller 1400 allows the massage module 100 to stand by at the corresponding position, and when the tilting frame 20 tilts in the forward (or upward) direction thereof, the controller 1400 operates the tilting actuator 60 to tilt the massage module 100 in the forward direction of the massage module 100. In this case, the controller 1400 tilts (or moves) the upper side massagers 110 of the massage module 100 in the forward direction of the massage module 100. As a result, the massage module 100 provides the additional standing assistive force increasing the standing assistive force generated according to the tilting operation of the support structure to the user.

That is, the massage module 100 moves along the rack gears 90 to help the user's standing in the standing assistive mode as well as to massage the user's body.

For another example, the standing assistive means consists of the massage module 100, the seat plate 31, and the seat lifting unit. In the case where the standing assistive means consists of the massage module 100, the seat plate 31, and the seat lifting unit, the above-mentioned operations are all performed, and therefore, repeated explanations will be avoided.

That is, the standing assistive means pushes the user's body through the massage module 100 and pushes the seat plate 31 through the seat lifting unit, thereby providing the additional standing assistive force for helping the user's standing to the user.

Next, the reclining means will be explained in detail.

According to an embodiment of the present invention, the seat frame 30 and the backrest frame 40 are located to be varied up and down in angle on the tilting frame 20 through the reclining means, thereby performing the reclining function. In this case, the reclining means is located on the lower portion of the support structure to recline the support structure. The reclining means tilts (or rotates) the seat frame 30 and the backrest frame 40 with respect to the tilting frame 20 to vary the angles of the seat frame 30 and the backrest frame 40 with respect to the floor.

According to an embodiment of the present invention, the reclining means includes reclining rails 72, the plurality of reclining rollers 73, and a reclining actuator 70.

The reclining rails 72 are curved upward and downward and disposed on both sides of the seat frame 30 and/or the backrest frame 40.

The plurality of reclining rollers 73 are located on the front and rear sides of the upper portion of the tilting frame 20 in such as a way as to insertedly guide the reclining rails 72.

The reclining actuator 70 has an operating rod 71. One end portion of the operating rod 71 is hinge-coupled to the rear end portion of the tilting frame 20, and the other end portion thereof to the front end portion of the seat frame 30. The operating rod 71 linearly reciprocates by means of a motor in such a way as to be expanded and contracted.

As shown in FIGS. 4 to 8, the reclining actuator 70 is an electric actuator whose operating rod 71 operates by the motor, but the reclining actuator 70 may be a hydraulic actuator whose operating rod 71 is expanded and contracted by the pressure of a fluid supplied from a hydraulic supply device (not shown).

If the massage device 1000 is in the normal state (or initial state) (See FIG. 5) and the motor of the reclining actuator 70 operates to expand the operating rod 71, the reclining rails 72 move forward by means of the guide of the reclining rollers 73 of the tilting frame 30, so that the seat frame 30 is lifted, and contrarily, the backrest frame 40 is descended. Accordingly, as shown in the left portion of FIG. 6, the massage device 1000 is changed into a weightless state (reclined state), thereby allowing the user to lie down thereon.

If the massage device 1000 is in the weightless state and the motor of the reclining actuator 70 operates to contract the operating rod 71, the reclining rails 72 move backward by means of the guide of the reclining rollers 73 of the tilting frame 30, so that the seat frame 30 is descended, and contrarily, the backrest frame 40 is lifted. Accordingly, the massage device 1000 is changed (or returned) into the normal state, thereby allowing the user to sit therein.

Referring to FIGS. 7 and 8, a leg frame 50 as the support structure of the leg massage parts 1300 (See FIG. 1) is rotatably connected to the front end portion of the seat frame 30. The leg frame 50 supports the calves and feet of the user through a leg driving part in such a way as to allow top end portion thereof to be rotatable around a hinge shaft 51 located on the front end portion of the seat frame 30.

The leg driving part rotates the leg frame 50 around the hinge shaft 51. The rear end portion of the leg driving part is hinge-coupled to the rear end portion of the seat frame 30, and the front end portion thereof to the leg frame 50. The leg driving part includes a leg actuator 80 having an operating rod 81 linearly reciprocating by means of a motor in such a way as to be expanded and contracted.

The leg frame 50 is connected to the front end portion of the seat frame 30 in such a way as to extend downward therefrom, and if the tilting actuator 60 operates to rotate the front end portion of the seat frame 30 downward in the state where the leg frame 50 is folded, the bottom of the leg frame 50 collides against the floor, the base frame 10, and/or a structure installed on the base frame 10 and is thus damaged. Further, vibrations and noise are generated from the collision impacts.

To prevent such problems from occurring, a hinge bracket 52 with the hinge shaft 51 installed on the front end portion of the seat frame 30 is disposed rotatable up and down around a bracket shaft 53, and if the tilting frame 20 rotates upward around the tilting shafts 21 to cause the bottom of the leg frame 50 to come into contact with the floor and/or the base frame 10, the hinge bracket 52 rotates upward to a given angle around the bracket shaft 53, thereby preventing collision from occurring.

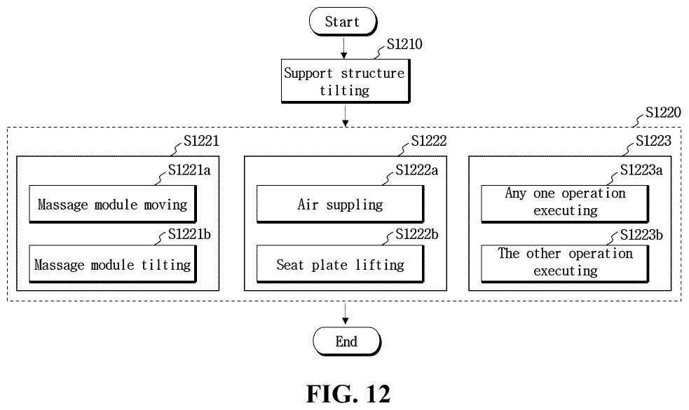

FIG. 12 shows an example of a standing assistive operation of the controller of the massage device according to the embodiment of the present invention.

As mentioned above, the controller 1400 (See FIG. 2) controls the operations of the support structure and the standing assistive means if the standing assistive mode is executed, thereby helping the user's standing. In this case, as mentioned above, the standing assistive means includes at least one among the seat plate 31, the seat lifting unit, and the massage module 100.

First, the controller 1400 tilts the support structure in the forward direction of the support structure through the standing assistive tilting means to provide the standing assistive force to the user (Step S1210). For example, as mentioned above, the controller 1400 operates the tilting actuator 60 to tilt the tilting frame 20 in the forward (or upward) direction of the tilting frame 20.

After that, the controller 1400 controls the operation of the standing assistive means in the state where the support structure tilts in the forward direction of the support structure, thereby providing the additional standing assistive force to the user (Step S1220).

For example, the controller 1400 performs at least one of the tilting operation where the massage module 100 tilts in the forward direction thereof and the lifting operation where the seat plate 31 is lifted in the upward direction thereof in the state where the support structure tilts.

For example, the controller 1400 controls the operation of the massage module 100, in the state where the support structure tilts, to perform the tilting operation where the massage module 100 tilts in the forward direction thereof (Step S1221).

For example, the controller 1400 moves the massage module 100 to the region corresponding to the user's lower body on the entire region of the support structure (Step S1221a). In this case, the controller 1400 may move the massage module 100 in the state where the support structure tilts. The controller 1400 may move the massage module 100, while tilting the support structure. The controller 1400 may move the massage module 100 before the support structure tilts and then tilt the support structure. In the case where the controller 1400 moves the massage module 100 before the support structure tilts, the controller 1400 moves the massage module 100 as soon as the standing assistive mode is executed.

In detail, the controller 1400 controls the moving part 120 to move the massage module 100 to the region corresponding to the user's lower body on the entire region of the rack gears 90.

The controller 1400 tilts the massage module 100 in the state where the massage module 100 moves (Step S1221b).

For another example, the controller 1400 controls the operation of the seat lifting unit, in the state where the support structure tilts, to perform the lifting operation where the seat plate 31 is lifted in the upward direction thereof (Step S1222).

For example, the controller 1400 supplies air to the lifting airbag 33 through the air supply part (Step S1222a).

The controller 1400 expands the lifting airbag 33 through the air supply to lift the seat plate 31 in the upward direction thereof around the seat hinge shaft 32 (Step S1222b).

For another example, the controller 1400 controls the operations of the massage module 100 and the seat lifting unit to perform the tilting operation and the lifting operation in the state where the support structure tilts (Step S1223).

For example, the controller 1400 performs any one of the tilting operation and the lifting operation (Step S1223a), and next, the controller performs the other operation (Step S1223b).

In detail, the controller 1400 performs the tilting operation after the lifting operation has been performed or performs the lifting operation after the tilting operation has been performed. However, the controller 1400 may perform the tilting operation and the lifting operation, simultaneously. The tilting operation and the lifting operation are the same as in Steps S1221 and S1222, and explanations of them will be avoided.

In the case where the controller 1400 performs the tilting operation after the lifting operation has been performed, the controller 1400 moves the massage module 100, while expanding the lifting airbag 33 as mentioned in Step S1221, and otherwise, the controller 1400 moves the massage module 100 after the lifting airbag 33 has been expanded.

As a result, the controller 1400 provides the standing assistive force generated through the support structure and the additional standing assistive force generated through the standing assistive means to the user, thereby helping the user's standing.

As mentioned above, the controller 1400 performs at least one of the tilting operation for the massage module 100 and the lifting operation for the seat plate 31 in the state where the support structure tilts, but of course, it may not be limited thereto.

For example, the controller 1400 may perform at least one of the tilting operation for the massage module 100 and the lifting operation for the seat plate 31 and next may perform the tilting operation for the support structure. Otherwise, the controller 1400 may perform the tilting operation for the support structure, the tilting operation for the massage module 100, and the lifting operation for the seat plate 31, simultaneously. Otherwise, the controller 1400 may perform the two operations among the tilting operation for the support structure, the tilting operation for the massage module 100, and the lifting operation for the seat plate 31, simultaneously and next may perform the remaining operation.

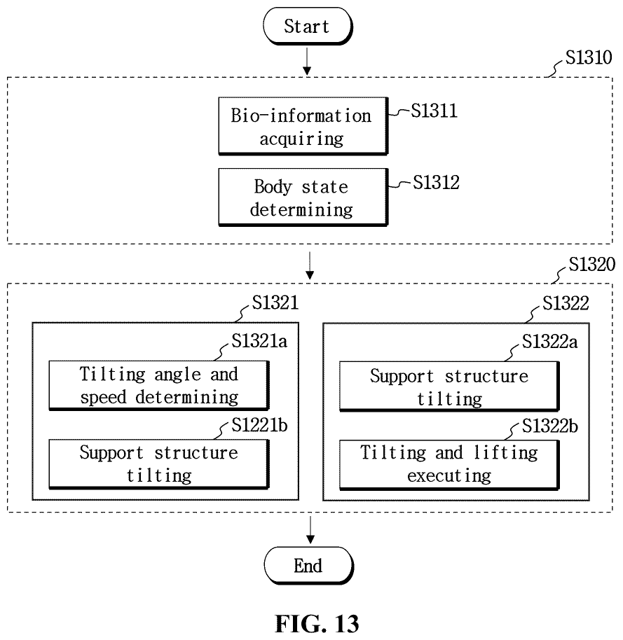

FIG. 13 shows another example of the standing assistive operation of the controller of the massage device according to the embodiment of the present invention.

The controller 1400 performs at least one among the tilting operation for the support structure, the tilting operation for the massage module 100, and the lifting operation for the seat plate 31, based on the user's body state. In this case, the user's state is at least one of a healthy state where the user's body is healthy and an unhealthy state where the user's body is unhealthy.

First, the controller 1400 determines the user's body state as at least one of a first state (e.g., healthy state) and a second state (e.g., unhealthy state) according to the user's bio-information (Step S1310).

For example, the controller 1400 acquires the user's bio-information received from at least one among the sensors included in the massage device 1000, the input part 1450 of the massage device 1000, and the external devices 3000 (Step S1311). The user's bio-information includes a biotic index of at least one among the user's age, height, weight, blood pressure, body composition, heart rate, and electrocardiogram.

The massage device 1000 includes at least one of a pressure sensor disposed on the seat 1101 and an electrode disposed on the arm massage parts 1200. For example, the pressure sensor detects the user's weight and transmits the detected information to the controller 1400. The controller 1400 acquires the information of the user's weight received from the pressure sensor. The controller 1400 acquires the changes in electricity value of the electrode according to the contact between the electrode and the user's arm and obtains the user's bio-information through the changes in the electricity value. In this case, the bio-information includes at least one among the user's body composition, heart rate, and electrocardiogram. The electricity value is at least one among the current, voltage, resistance, and impedance of the electrode.

As mentioned above, the massage device 1000 includes the pressure sensor and the electrode, but it may not be limited thereto. For example, the massage device 1000 may include various sensors for detecting, measuring, and acquiring various bio-information of the user. The controller 1400 acquires the user's bio-information received from the various sensors of the massage device 1000.

The controller 1400 acquires the user's bio-information through the massage module 100. In this case, the bio-information is the user's height. For example, the controller 1400 controls the massage module 100 to acquire the user's shoulder height, and based on the user's shoulder height, it determines the user's height.

The input part 1450 and the external devices 3000 produce the user's bio-information according to the user's inputs and transmits the produced bio-information to the controller 1400. In this case, the bio-information is the user's bio-information of age, height, weight, blood pressure, body composition, heart rate, and electrocardiogram.

The controller 1400 determines whether the user's bio-information is similar to preset normal bio-information to determine the user's body state as at least one of the healthy state and the unhealthy state according to the determined result (Step S1312). In this case, the normal bio-information is preset by at least one among various objects, such as a manufacturer of the massage device 1000, a seller of the massage device 1000, a user of the massage device 1000, and a manager of the massage device 1000 and stored in the memory 1430. For example, the normal bio-information includes at least one among normal weights, body compositions, blood pressures, heart rates, and electrocardiogram according to heights.

If the user's bio-information is similar to the normal bio-information, the controller 1400 determines the user's body state as the healthy state. For example, in at least one case where the user's weight is similar to the normal weight, the user's body composition is similar to the normal body composition, the user's body pressure is similar to the normal body pressure, the user's heart rate is similar to the normal heart rate, and the user's electrocardiogram is similar to the normal electrocardiogram, the controller 1400 determines the user's body state as the healthy state.

Contrarily, if the user's bio-information is different from the normal bio-information, the controller 1400 determines the user's body state as the unhealthy state. For example, in at least one case where the user's weight is different from the normal weight, the user's body composition is different from the normal body composition, the user's body pressure is different from the normal body pressure, the user's heart rate is different from the normal heart rate, and the user's electrocardiogram is different from the normal electrocardiogram, the controller 1400 determines the user's body state as the unhealthy state.

After that, the controller 1400 performs at least one among the tilting operation for the support structure, the tilting operation for the massage module 100, and the lifting operation for the seat plate 31 according to whether the user's body state is determined as the healthy state.

For example, the controller 1400 tilts the support structure according to at least one of the tilting angle and the tilting speed for the support structure (Step S1321).

For example, the controller 1400 determines at least one of the tilting angle and the tilting speed for the support structure according to the user's body state (Step S1321a). In this case, the tilting angle for the support structure is the expansion and contraction length of the operating rod 61 of the tilting actuator 60. The tilting speed for the support structure is the expansion and contraction speed of the operating rod 61 of the tilting actuator 60.

If the user's body state is the healthy state, the controller 1400 determines the tilting angle corresponding to the healthy state among a plurality of predetermined tilting angles as the tilting angle for the support structure. In this case, the plurality of predetermined tilting angles are set by the above-mentioned various objects and stored in the memory 1430.

If the user's body state is the healthy state, the controller 1400 determines the tilting speed corresponding to the healthy state among a plurality of predetermined tilting speeds as the tilting speed for the support structure. In this case, the plurality of predetermined tilting speeds are set by the above-mentioned various objects and stored in the memory 1430.

If the user's body state is the unhealthy state, the controller 1400 determines the tilting angle corresponding to the unhealthy state among the plurality of predetermined tilting angles as the tilting angle for the support structure.

If the user's body state is the unhealthy state, the controller 1400 determines the tilting angle corresponding to the unhealthy state among a plurality of predetermined tilting angles as the tilting angle for the support structure.

The tilting angle corresponding to the healthy state is different from that corresponding to the unhealthy state. Desirably, the tilting angle corresponding to the unhealthy state is larger than that corresponding to the healthy state.

The tilting speed corresponding to the healthy state is different from that corresponding to the unhealthy state. Desirably, the tilting speed corresponding to the unhealthy state is faster than that corresponding to the healthy state.

The controller 1400 tilts the support structure according to at least one of the determined tilting angle and the determined tilting speed for the support structure (Step S1321b). For example, the controller 1400 controls the operation of the tilting actuator 60 according to at least one of the determined tilting angle and the determined tilting speed for the support structure and tilts the support frame in the forward direction of the support frame.

In detail, the controller 1400 controls the expansion and contraction length of the operating rod 61 of the tilting actuator 60 according to the tilting angle for the support structure and controls the expansion and contraction speed of the operating rod 61 according to the tilting speed for the support structure, thereby tilting the support structure.

For another example, the controller 1400 performs the tilting operation for the support structure according to the user's body state and next performs at least one of the tilting operation for the massage module 100 and the lifting operation for the seat plate 31 (Step S1322).

According to an embodiment of the present invention, the controller 1400 tilts the support structure as mentioned in the step S1321 (Step S1322a). If the user's body state is the unhealthy state, the controller 1400 performs at least one of the tilting operation for the massage module 100 and the lifting operation for the seat plate 31 (Step S1322b).

For example, the controller 1400 tilts the massage module 100 in the forward direction of the massage module 100 according to the user's body state in the state where the support structure tilts. The tilting operation of the massage module 100 has been explained in FIG. 12, and therefore, a repeated explanation will be avoided.

However, the controller 1400 determines at least one of the tilting angle and the tilting speed for the massage module 100 according to the user's body state. The controller 1400 tilts the massage module 100 according to at least one of the determined tilting angle and speed. In this case, the tilting angle is an angle by which the massage module 100 moves forward. The tilting speed is a speed at which the massage module 100 moves forward. The above-mentioned step S1321a is applicable in determining the tilting angle and speed for the massage module 100.

For example, the controller 1400 controls an amount of the massage module 100 moving forward through the tilting actuator of the massage module 100 according to the tilting angle for the massage module 100. The controller 1400 controls the forward moving speed of the massage module 100 through the tilting actuator of the massage module 100 according to the tilting speed for the massage module 100.

The controller 1400 lifts the seat plate 31 in the upward direction of the seat plate 31 according to the user's body state in the state where the support structure tilts. The lifting operation for the seat plate 31 has been explained in FIG. 12, and therefore, a repeated explanation will be avoided.

However, the controller 1400 determines at least one of the lifting strength and the lifting speed for the seat plate 31 according to the user's body state. In this case, the lifting strength is strength by which the seat plate 31 is lifted upward. The lifting speed is a speed at which the seat plate 31 is lifted upward.

If the seat lifting unit is the lifting air cell 33, the lifting strength is strength by which the lifting air cell 33 is expanded according to the amount of air supplied thereto. The lifting speed is a speed at which the lifting air cell 33 is expanded according to the rate of flow of air supplied thereto. The above-mentioned step S1321a is applicable in determining the lifting strength and speed for the seat plate 31.

The controller 1400 lifts the seat plate 31 according to at least one of the determined lifting strength and speed. If the seat lifting unit is the lifting air cell 33, the controller 1400 controls the amount of air to be supplied to the lifting air cell 3 according to the lifting strength, thereby expanding the lifting air cell 33. Further, the controller 1400 controls the rate of air to be supplied to the lifting air cell 3 according to the lifting speed, thereby expanding the lifting air cell 33.

The controller 1400 performs any one of the tilting operation for the massage module 100 and the lifting operation for the seat plate 31 according to the user's body state in the state where the support structure tilts and next performs the remaining operation of the tilting operation for the massage module 100 and the lifting operation for the seat plate 31.

According to the user's body state, as mentioned above, the controller 1400 performs the tilting operation for the support structure and next performs any one of the tilting operation for the massage module 100 and the lifting operation for the seat plate 31, but it may not be limited thereto.

According to the user's body state, for example, the controller 1400 may perform at least one of the tilting operation for the massage module 100 and the lifting operation for the seat plate 31 and next may perform the tilting operation for the support structure. According to the user's body state, otherwise, the controller 1400 may perform the tilting operation for the support structure, the tilting operation for the massage module 100, and the lifting operation for the seat plate 31, simultaneously. According to the user's body state, otherwise, the controller 1400 may perform the two operations among the tilting operation for the support structure, the tilting operation for the massage module 100, and the lifting operation for the seat plate 31, simultaneously and next may perform the remaining operation.

As mentioned above, the massage device 1000 according to the present invention is configured to have the seat frame 30 and the backrest frame 40 located on the tilting frame 20 disposed rotatable with respect to the base frame 10 and to allow the tilting actuator 60 disposed on the rear end portion of the tilting frame 20 to apply the force to the tilting frame 20 so that the rear portion of the tilting frame 20 is lifted upward, thereby allowing the seat frame 30 and the backrest frame 40 to be slant forward.

Accordingly, the massage device 1000 according to the present invention is simplified in the configuration capable of adjusting the seat frame 30 and the backrest frame 40 to the standing assistive angle and possible to achieve stable standing assistive operation. That is, the massage device 1000 includes a variety of electrical and machine parts, and the electrical and machine parts are located in a space between the base frame 10 and the seat frame 30, which prevents the size of the massage device 1000 from being bulky. In this case, the electrical and machine parts include at least one or more among the motors and air compressors for driving the massage module and the air cell, the control device, etc.

The massage device 1000 according to the present invention is configured to locate the tilting frame 20 and the tilting actuator 60 in the space between the base frame 10 and the seat frame 30, so that through the simple configuration and operating mechanism, the seat frame 30 and the backrest frame 40 tilt (or rotate) to perform the standing assistive function.

When the tilting actuator 60 operates to perform the standing assistive mode wherein the tilting frame 20 rotates upward, the massage device 1000 according to the present invention makes use of the standing assistive means to apply the force for pushing the user's hips forward, thereby increasing the standing assistive force. Accordingly, the user's standing from the massage device 1000 is more easily and comfortably performed.

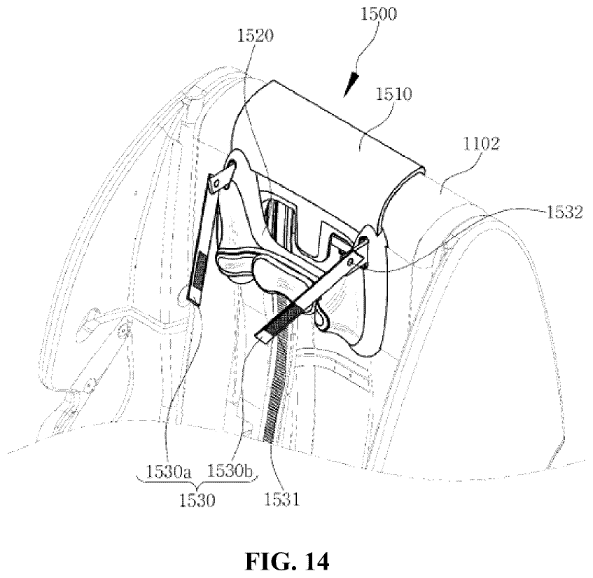

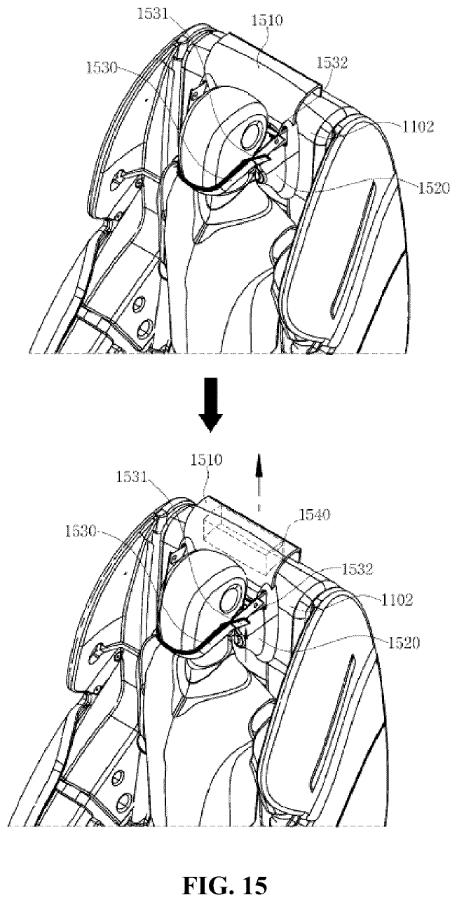

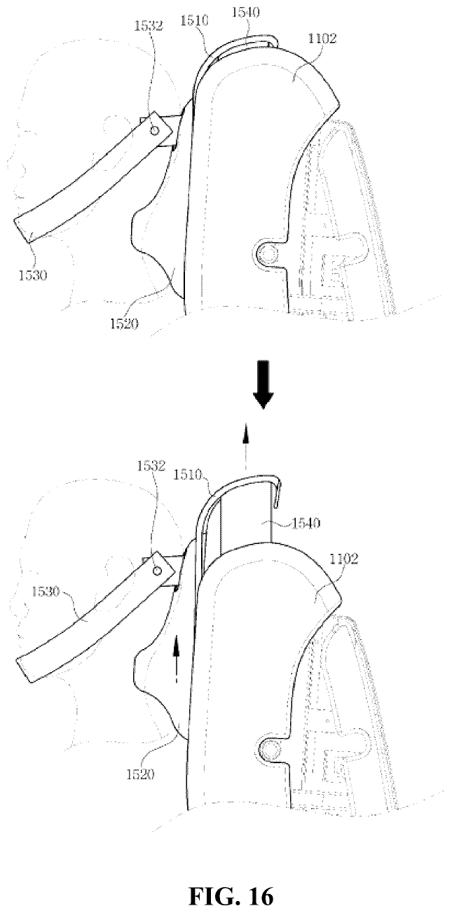

Further, the massage device 1000 according to the present invention includes a neck traction module 1500 adapted to pull and stretch the user's neck, as shown in FIGS. 14 to 16.

The neck traction module 1500 serves to pull and stretch the user's chin and back neck upward, that is, in a vertical direction in a state where the user sits in the massage device 1000, thereby providing cervical traction effects.

According to an embodiment of the present invention, the neck traction module 1500 includes a traction base member 1510 located on top of the backrest 1102 of the massage device 1000, a back neck traction part 1520 protruding forward from the lower portion of the traction base member 1510 in such a way as to come into close contact with the user's back neck, a fixing strap 1530 whose both ends are connected to the traction base member 1510 and/or the back neck traction part 1520 in such a way as to fixedly surround the user's chin, and a traction driving part 1540 for pushingly lifting the traction base member 150 upward.

The traction base member 1510 has the shape of a sheet made of a flexible material such as leather, fabric, resin, and the like and is located on top of the backrest 1102 in such a way as to extend forward and backward therefrom. One side end portion of the traction base member 1510 is coupled to the rear side of top of the backrest 1102, and the other side end portion thereof is freely located on the front side of top of the backrest 1102 so that the traction base member 1510 is pushed and lifted upward by means of the traction driving part 1540. In this case, one side end portion of the traction base member 1510 is detachably coupled to the rear side of top of the backrest 1102 by means of a Velcro tape, a snap button, a hook, and/or a clip. Otherwise, one side end portion of the traction base member 1510 may be fixedly coupled to the rear side of top of the backrest 1102 by means of sewing or an adhesive.

The back neck traction part 1520 extends in left and right directions from the lower portion of the front side of the traction base member 1510 in such a way as to come into close contact with the user's back neck, and the back neck traction part 1520 is three-dimensionally shaped to have an arch-shaped curved surface formed on the front surface thereof so that when pulled upward, the back neck traction part 1520 pulls the user's back neck upward. The back neck traction part 1520 is made of a hard material, unlike the traction base member 1510.

The fixing strap 1530 serves to fixedly surround the user's chin to pull the user's chin together with the back neck traction part 1520. According to the embodiment of the present invention, the fixing strap 1530 consists of a pair of first fixing strap 1530a and second fixing strap 1530b, and one end of the first fixing strap 1530a and one end of the second fixing strap 1530b are fixed to tops of both sides of the back neck traction part 1520, whereas the other end of the first fixing strap 1530a and the other end of the second fixing strap 1530b are fastened or separated to and from each other by means of strap locking members 1531 such as Velcro tapes, buckles, and the like. Otherwise, one end of the first fixing strap 1530a and one end of the second fixing strap 1530b are fixed to the traction base member 1510.

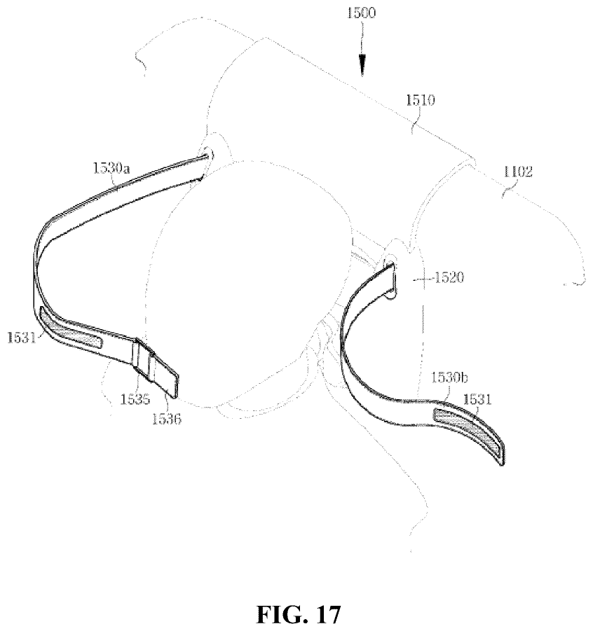

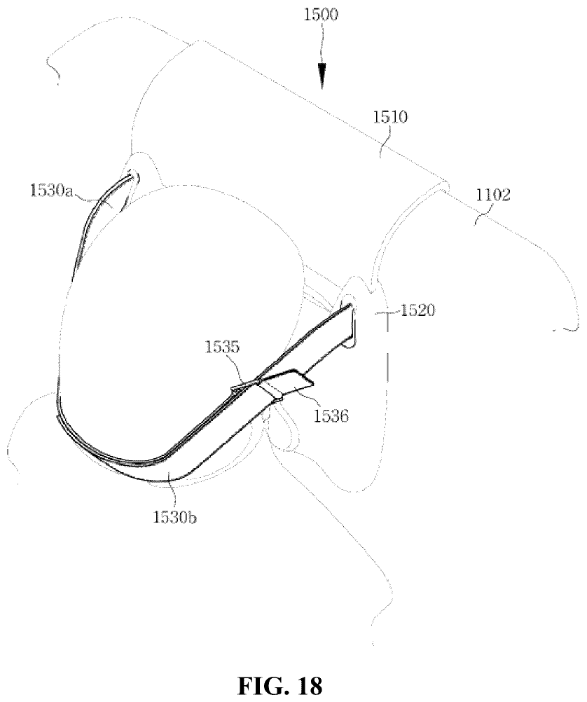

As shown in FIGS. 17 and 18, further, a fastening loop 1535 is located on one end portion of the first fixing strap 1530a to easily adjust the length of the fixing strap 1530 according to the user's face size, and accordingly, the second fixing strap 1530b passes through the fastening loop 1535 and comes into close contact with the user's chin and/or forehead, while the length of the fixing strap 1530 is being adjusted according to the user's face size. Next, the first fixing strap 1530a and the second fixing strap 1530b are fastened to each other by means of the strap locking members 1531.

The fastening loop 1535 has the shape of a general rectangle in such a way as to allow one end thereof to be connected to the first fixing strap 1530a. The other end of the fastening loop 1535 is connected to a handle strap 1536 held by the user's hand to easily pass the second fixing strap 1530b through the fastening loop 1535 so that the length adjustment and the fastening of the fixing strap 1530 are completed.

Velcro tapes are used as the strap locking members 1531 located on the first fixing strap 1530a and/or the second fixing strap 1530b so that they easily pass through the fastening loop 1535, but of course, various detachable instruments may be used as the strap locking members 1531.

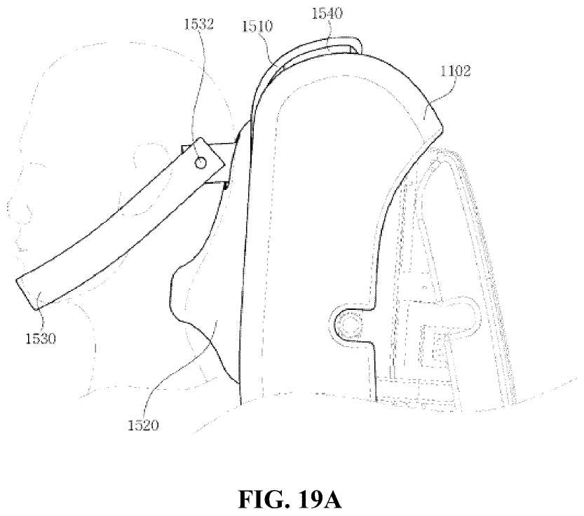

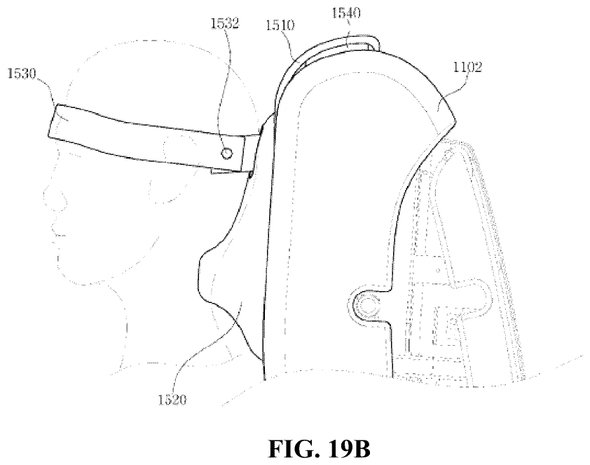

Further, as shown in FIGS. 19A and 19B, the end portions of the first and second fixing straps 1530a and 1530b are rotatably connected to both sides of the back neck traction part 1520 or the traction base member 1510 by means of hinge pins 1532, so that if necessary, the fixing strap 1530 is fixed to surround the user's chin, as shown in FIG. 19A, and the fixing strap 1530 is fixed to surround the user's forehead, as shown in FIG. 19B.

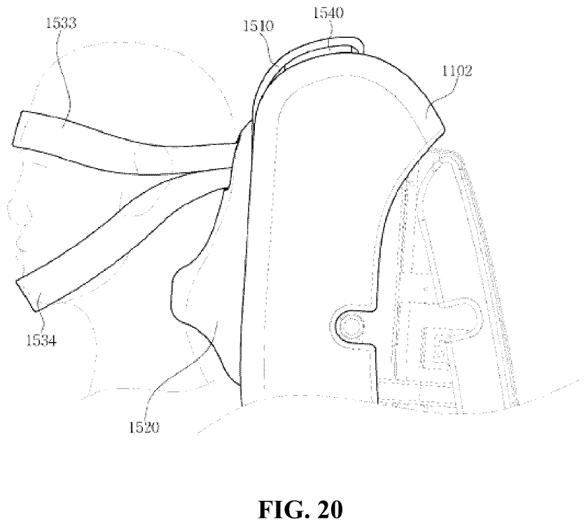

Otherwise, as shown in FIG. 20, the fixing strap 1530 is divided into a forehead fixing strap 1533 for surroundingly fixing the user's forehead and a chin fixing strap 1534 for surroundingly fixing the user's chin, independently of each other.

In this case, as mentioned above, the forehead fixing strap 1533 consists of a pair of forehead fixing straps and the chin fixing strap 1534 consists of a pair of chin fixing straps, so that they are fixed to both sides of the back neck traction part 1520 or the traction base member 1510.

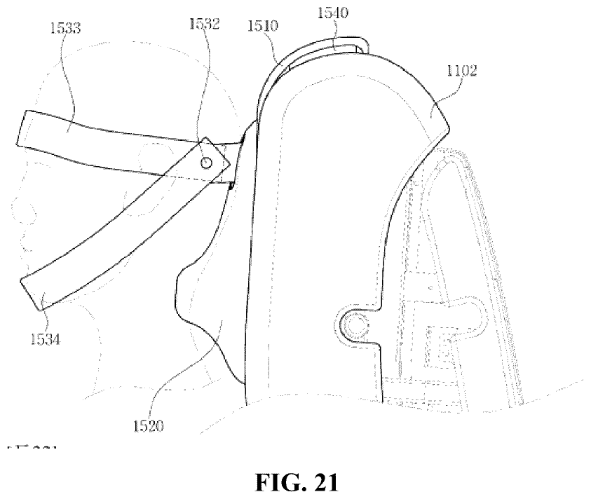

Further, as shown in FIG. 21, the forehead fixing strap 1533 and the chin fixing strap 1534 are rotatably connected to both sides of the back neck traction part 1520 or the traction base member 1510 by means of the hinge pins 1532, so that they are fixed to surround the user's forehead and chin.

Further, in the embodiments as shown in FIGS. 19 to 21, the fastening loop 1535 and the handle strap 1536 as shown in FIG. 17 are provided to any one side end of the pair of fixing straps 1530, the forehead fixing straps 1533, and the chin fixing straps 1534, so that the lengths of the fixing straps 1530, the forehead fixing straps 1533, and the chin fixing straps 1534 are adjusted to fixedly surround the user's forehead and/or chin.

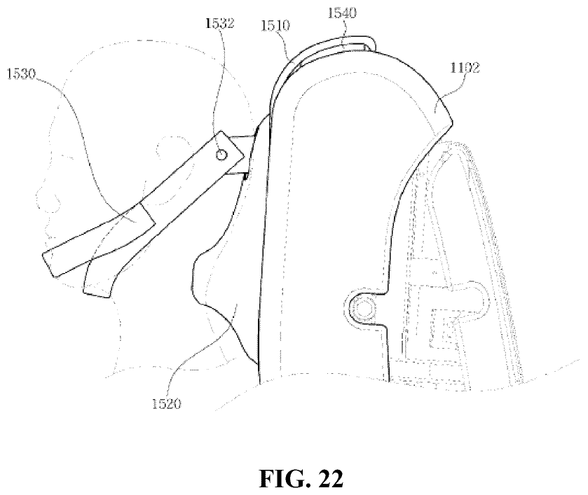

Further, as shown in FIG. 22, the portion of the fixing strap 1530 coming into close contact with the user's chin is divided into two straps so that when the fixing strap 1530 fixes the user's chin thereto, the upper chin and the lower chin of the user are stably supported against the two fixing straps.

Referring back to FIGS. 14 to 16, the traction driving part 1540 applies an external force to top of the traction base member 1510 with respect to top of the backrest 1102, so that the back neck traction part 1520 and the fixing strap 1530 move upward together to pull the back neck and the chin simultaneously. According to the embodiment of the present invention, an airbag (or air cell) as the traction driving part 1540, which is located on top of the backrest 1102, is expanded by the air supplied thereto to push the traction base member 1510 upward. However, of course, a known actuator applying an external force to the traction base member 1510 in an upward direction may be used as the traction driving part 1540.

If it is desired to perform cervical stretching using the neck traction module 1500, a neck traction mode is executed under the control of the controller 1400 in a state where the user's chin is fixedly surrounded by the fixing strap 1530, and next, air is supplied to the traction driving part 1540 through an air supply part to expand the traction driving part 1540 as the air bag under the control of the controller 1400.

If the traction driving part 1540 expands, a given force is applied to the traction base member 1510 in an upward direction, and accordingly, the front side of the traction base member 1520, which is freely located on the backrest 1102, without being fixed thereto, is pushed and lifted upward from top of the backrest 1102. As a result, the back neck traction part 1520 and the fixing strap 1530 move upward together with the traction base member 1510 so that cervical traction is performed to pull the user's back neck and chin simultaneously in the upward direction with respect to a vertical direction.

Next, if the air supply to the traction driving part 1540 is stopped by the control of the controller 1400, the traction driving part 1540 contracts to allow the traction base member 1510 to move down, so that cervical release is performed.

The controller 1400 performs the operation for supplying air to the traction driving part 1540 and the operation for stopping air supply to the traction driving part 1540 according to a predetermined sequence, thereby executing the cervical traction and release.

The neck traction mode through the neck traction module 1500 is executed irrespective of the angles of the seat 1101 and the backrest 1102, but in the normal state, when the neck traction mode is executed in the standing assistive state where the tilting frame 20 (See FIG. 8) rotates to move the seat 1101 downward and move the backrest 1102 forward, the cervical traction effects are obtained more effectively.

When the cervical traction function is performed through the operation of the traction driving part 1540, a traction force has to be controlled to prevent an excessive force from being applied to the cervical region, and desirably, the traction force is in the range about 5 to 15 kgf. To allow the traction force generated from the traction driving part 1540 to be appropriately controlled, a pressure sensor for measuring an air pressure of the traction driving part 1540 is additionally provided.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A massage device comprising:
a main frame for supporting at least a region of a user's body;
a base frame disposed under the main frame to support the main frame;
a tilting frame disposed between the main frame and the base frame in such a way as to be connected to tilting shafts provided at the front of the base frame and extending in a lateral direction; and
a tilting means disposed between the base frame and the tilting frame to tilt the tilting frame around the tilting shafts.

2. The massage device according to claim 1, wherein the base frame comprises first base frames disposed on the front side thereof in such a way as to extend in a first direction, and the tilting frame comprises first tilting frames disposed on the front side thereof in such a way as to extend in a second direction, so that at least portions of the upper portions and lower portions of the first tilting frames are tiltably connected to upper end portions of the first base frames by means of the tilting shafts.

3. The massage device according to claim 2, wherein the first direction is an upward direction from the base frame, and the second direction is a downward direction from the tilting frame.

4. The massage device according to claim 3, wherein the tilting shafts are located on the upper end portions of the first base frames in such a way as to extend in the lateral direction.

5. The massage device according to claim 4, wherein the tilting means has one end connected to the front side of the base frame and the other end connected to the rear side of the tilting frame.

6. The massage device according to claim 5, wherein the tilting means is adjusted in the length between one end and the other end thereof to tilt the tilting frame around the tilting shafts.

7. The massage device according to claim 5, wherein the tilting frame comprises second tilting frame disposed on the rear side thereof in such a way as to extend in the second direction and reinforcing tilting frames for connecting the first tilting frames and the second tilting frames.

8. The massage device according to claim 7, wherein the reinforcing tilting frames comprise first reinforcing tilting frames disposed on one side of the first tilting frames, second reinforcing tilting frames disposed on one side of the second tilting frames, and third reinforcing tilting frames disposed between the first reinforcing tilting frames and the second reinforcing tilting frames.

9. The massage device according to claim 8, wherein the third reinforcing tilting frames comprise third upper side reinforcing tilting frames for connecting the upper portions of the first reinforcing tilting frames and the upper portions of the second reinforcing tilting frames to support the main frame thereagainst, and third lower side reinforcing tilting frames located under the third upper side reinforcing tilting frames.

10. The massage device according to claim 9, wherein the first base frames have different lengths from second base frames disposed on the rear side of the base frame in such a way as to extend in the first direction, and the first reinforcing tilting frames have different lengths from the second reinforcing tilting frames.

11. The massage device according to claim 10, wherein the first base frames have lengths longer than the second base frames, and the first reinforcing tilting frames have lengths shorter than the second reinforcing tilting frames.

12. The massage device according to claim 11, wherein the second base frames support the second reinforcing tilting frames.

13. The massage device according to claim 12, further comprising buffering members located on at least one of the upper portions of the second base frames and the lower portions of the second reinforcing tilting frames.

14. The massage device according to claim 13, wherein the buffering members are formed of elastic materials.
